(19) United States
(12) Patent Application Publication
(10) Pub. No.: US 2024/0201425 A1
(43) Pub. Date: Jun. 20, 2024

(54) IMAGE DISPLAY DEVICE

(71) Applicant: NICHIA CORPORATION, Anan-shi (JP)

(72) Inventors: Hajime AKIMOTO, Anan-shi (JP); Kazuhiro MIYAGI, Anan-shi (JP); Masakazu KOTANI, Anan-shi (JP)

(73) Assignee: NICHIA CORPORATION, Anan-shi (JP)

(21) Appl. No.: 18/508,974

(22) Filed: Nov. 14, 2023

(30) Foreign Application Priority Data
Dec. 14, 2022 (JP) 2022-199670

(51) Int. Cl. G02B 5/124; G02B 30/56

(52) U.S. Cl. CPC G02B 5/124; G02B 30/56

(57) ABSTRACT

An image display device includes an imaging element and multiple light sources. The imaging element reflects light of the multiple light sources and forms multiple floating images in mid-air. The imaging element includes a base member including a first surface, and a reflector array on the base member. The reflector array includes multiple reflector rows including multiple dihedral corner reflectors along a first direction. The multiple reflector rows are arranged parallel to a second direction crossing the first direction. The multiple dihedral corner reflectors each include a first reflecting surface, and a second reflecting surface orthogonal to the first reflecting surface.

### CROSS-REFERENCE TO RELATED APPLICATIONS

The present application claims priority under 35 U.S.C. § 119 to Japanese Patent Application No. 2022-199670, filed Dec. 14, 2022, the contents of which are hereby incorporated by reference in their entirety.

### BACKGROUND

### 1. Technical Field

Embodiments of the invention described herein relate to a method for manufacturing an image display device.

### 2. Description of Related Art

A reflective imaging optical element that displays a real image of an object to be observed in mid-air and an image display device using the reflective imaging optical element have been proposed (see, e.g., Japanese Patent Publication No. 2015-146009).

Such an image display device can display an image when needed by a user, and may not display the image at other times. Such an image display device requires no device for the display part because the image is displayed in mid-air. Such an image display device therefore has advantages such as more effective utilization of the limited space inside an automobile or the like.

A non-contact operation panel can be realized by applying such an image display device. Therefore, there are expectations for expanding the field of application beyond the utilization in automobiles and the like.

Reflective imaging optical elements that can display images in mid-air, such as those that use dihedral corner reflectors or retroreflective function optical elements called corner cube reflectors, have been put into practical use (see, e.g., PCT Publication No. WO2016/199902). Attention has been called to problems resulting from the operation principles of each. For example, in an image display device using imaging elements having dihedral corner reflectors, it is said to be difficult to avoid the display of false images at locations unintended by the user.

In an image display device using a corner cube reflector, the formation position of the floating image can be set relatively freely by using an optical element in addition to a light source and imaging element. On the other hand, the configuration of such an optical element is complex.

An image display device having a simple structure that can display an image in mid-air is desirable.

### SUMMARY

Certain embodiments of the present disclosure provide an image display device having a simple structure that can display an image in mid-air.

An image display device according to one embodiment of the invention includes multiple light sources, and an imaging element that reflects light of the multiple light sources and forms multiple floating images in mid-air. The imaging element includes a base member, and a reflector array provided on the base member, wherein the base member includes a first surface and a second surface, and the second surface is positioned at a side opposite to the first surface, or a base member including a reflector array, wherein the base member includes a first surface and a second surface, and the second surface is positioned at a side opposite to the first surface. The reflector array includes multiple reflector rows, wherein the multiple reflector rows include multiple dihedral corner reflectors arranged along a first direction. The multiple dihedral corner reflectors each includes a first reflecting surface configured to reflect light from the first surface side, and a second reflecting surface oriented to be orthogonal to the first reflecting surface, and configured to reflect a reflected light from the first reflecting surface toward the first surface side. In each reflector row of the multiple reflector rows, an angle between a first straight line at which the first reflecting surface and the second reflecting surface meet and a plane in which the first direction and a second direction intersecting the first direction extend is set to a value greater than 0° and less than 90°. An angle between the first reflecting surface and the plane is set to a value greater than 45° and less than 90°. The multiple reflector rows include a first reflector row in which the angle between the first straight line and the plane is set to a smallest value among those of the multiple reflector rows. The other reflector rows of the multiple reflector rows are configured such that the angle between the first straight line and the plane is set to values that increase away from the first reflector row along the second direction.

An image display device according to another embodiment of the invention includes a light source, and multiple imaging elements that reflect light from the light source and form multiple floating images in mid-air. Each of the imaging elements includes a base member, and a reflector array provided on the base member, wherein the base member includes a first surface and a second surface, and the second surface is positioned at a side opposite to the first surface, or a base member including a reflector array, wherein the base member includes a first surface and a second surface, and the second surface is positioned at a side opposite to the first surface. The reflector array includes multiple reflector rows, wherein the multiple reflector rows include multiple dihedral corner reflectors arranged along a first direction. Each of the multiple dihedral corner reflectors includes a first reflecting surface configured to reflect light from the first surface side, and a second reflecting surface oriented to be orthogonal to the first reflecting surface, and configured to reflect a reflected light from the first reflecting surface toward the first surface side. In each reflector row of the multiple reflector rows, an angle between a first straight line at which the first reflecting surface and the second reflecting surface meet and a plane in which the first direction and a second direction intersecting the first direction extend is set to a value greater than 0° and less than 90°. An angle between the first reflecting surface and the plane is set to a value greater than 45° and less than 90°. The multiple reflector rows include a first reflector row in which the angle between the first straight line and the plane is set to a smallest value among those of the multiple reflector rows. The other reflector rows of the multiple reflector rows are configured such that the angle between the first straight line and the plane is set to values that increase away from the first reflector row along the second direction.

An image display device according to another embodiment of the invention includes multiple light sources, and an imaging element that reflects light of the multiple light sources and respectively forms multiple floating images in mid-air. The imaging element includes a base member, and a reflector array provided on the base member, wherein the base member includes a first surface and a second surface, and the second surface is positioned at a side opposite to the first surface, or a base member including a reflector array, wherein the base member includes a first surface and a second surface, and the second surface is positioned at a side opposite to the first surface. The reflector array includes multiple reflector rows, wherein the multiple reflector rows include multiple dihedral corner reflectors arranged along a first direction. The multiple reflector rows are arranged in a second direction to be parallel to each other with a spacing therebetween, wherein the second direction intersects the first direction. Each of the multiple dihedral corner reflectors includes a first reflecting surface configured to reflect light from the first surface side, and a second reflecting surface oriented to be orthogonal to the first reflecting surface, and configured to reflect a reflected light reflected from the first reflecting surface toward the first surface side. In each reflector row of the multiple reflector rows, an angle between a first straight line at which the first reflecting surface and the second reflecting surface meet and a plane in which the first direction and the second direction intersect is set to a value greater than 0° and less than 90°. An angle between the first reflecting surface and the plane is set to a value greater than 45° and less than 90°. The multiple reflector rows include a first reflector row in which the angle between the first straight line and the plane is set to a smallest value among those of the plurality of reflector rows. The other reflector rows of the multiple reflector rows are configured such that the angle between the first straight line and the plane is set to values that increase away from the first reflector row in one direction along the second direction.

An image display device according to another embodiment of the invention includes a light source, and multiple imaging elements that reflect light of the light source and respectively form multiple floating images in mid-air. Each of the imaging elements includes a base member, and a reflector array provided on the base member, wherein the base member includes a first surface and a second surface, and the second surface is positioned at a side opposite to the first surface, or a base member includes a reflector array, wherein the base member includes a first surface and a second surface, and the second surface is positioned at a side opposite to the first surface. The reflector array includes multiple reflector rows, wherein the plurality of reflector rows includes a plurality of dihedral corner reflectors arranged along a first direction. The multiple reflector rows are arranged in a second direction to be parallel to each other with a spacing therebetween, wherein the second direction intersects the first direction. Each of the multiple dihedral corner reflectors includes a first reflecting surface configured to reflect light from the first surface side, and a second reflecting surface oriented to be orthogonal to the first reflecting surface, and configured to reflect a reflected light reflected from the first reflecting surface toward the first surface side. In each reflector row of multiple reflector rows, an angle between a first straight line at which the first reflecting surface and the second reflecting surface meet and a plane in which the first direction and a second direction intersect is set to a value greater than 0° and less than 90°. An angle between the first reflecting surface and the plane is set to a value greater than 45° and less than 90°. The multiple reflector rows include a first reflector row in which the angle between the first straight line and the plane is set to a smallest value among those of the plurality of reflector rows. The other reflector rows of the multiple reflector rows are configured such that the angle between the first straight line and the plane is set to values that increase away from the first reflector row in one direction along the second direction.

### BRIEF DESCRIPTION OF THE DRAWINGS

FIG. 1 is a schematic cross-sectional view illustrating an image display device according to a first embodiment;

FIG. 2 is a schematic view for describing positions of display devices, an imaging element, and floating images of the image display device according to the first embodiment;

FIG. 3A is a schematic plan view illustrating a portion, i.e., the display device, of the image display device according to the first embodiment;

FIG. 3B is an enlarged schematic view of portion IIIB of FIG. 3A;

FIG. 4A is a schematic auxiliary cross-sectional view along line IVA-IVA of FIG. 3B;

FIG. 4B is a schematic cross-sectional view illustrating a portion, i.e., a modification of the display device, of the image display device according to the first embodiment;

FIG. 5 is a schematic equivalent circuit diagram illustrating a portion, i.e., the display device, of the image display device according to the first embodiment;

FIG. 6 is a schematic plan view illustrating a portion, i.e., an imaging element, of the image display device;

FIG. 7 is a schematic perspective view illustrating a portion, i.e., a base member, of the imaging element of FIG. 6;

FIG. 8 is an enlarged schematic view of portion VIII of FIG. 6;

FIG. 9A is a schematic plan view illustrating a portion, i.e., a dihedral corner reflector, of the imaging element of FIG. 8;

FIG. 9B is an example of a schematic auxiliary cross-sectional view along line IXB-IXB of FIG. 9A;

FIG. 9C is a schematic perspective view for describing an operation of the dihedral corner reflector of FIG. 9A;

FIG. 9D is a schematic perspective view for describing an operation of the dihedral corner reflector of FIG. 9A;

FIG. 10 is a schematic side view illustrating the imaging element of FIG. 6;

FIG. 11 is a schematic side view illustrating the imaging element of FIG. 6;

FIG. 12A is a schematic side view illustrating a portion, i.e., a modification of the imaging element, of the image display device according to the first embodiment;

FIG. 12B is a schematic side view illustrating a portion, i.e., another modification of the imaging element, of the image display device according to the first embodiment;

FIG. 13 is a schematic plan view for describing a portion, i.e., an operation of the imaging element, of the image display device according to the first embodiment;

FIG. 14 is a schematic side view for describing a portion, i.e., an operation of the imaging element, of the image display device according to the first embodiment;

FIG. 15 is a schematic side view for describing a portion, i.e., an operation of the imaging element, of the image display device according to the first embodiment;

FIG. 16 is a schematic cross-sectional view illustrating an image display device according to a second embodiment;

FIG. 17 is a schematic view for describing positions of display devices, an imaging element, and floating images of the image display device according to the second embodiment;

FIG. 18 is a schematic cross-sectional view illustrating an image display device according to a third embodiment;

FIG. 19 is a schematic cross-sectional view illustrating an image display device according to a fourth embodiment;

FIG. 20 is a schematic view for describing positions of a display device, imaging elements, and floating images of the image display device according to the fourth embodiment; and

FIG. 21 is a schematic cross-sectional view illustrating an image display device according to a fifth embodiment.

### DETAILED DESCRIPTION

Exemplary embodiments will now be described with reference to the drawings.

The drawings are schematic or conceptual, and the relationships between the thickness and width of portions, the proportional coefficients of sizes among portions, etc., are not necessarily the same as the actual values thereof. Furthermore, the dimensions and proportional coefficients may be illustrated differently among drawings, even for identical portions.

In the specification of the application and the drawings, components similar to those described in regard to a drawing thereinabove are marked with like reference numerals, and a detailed description is omitted as appropriate.

### First Embodiment

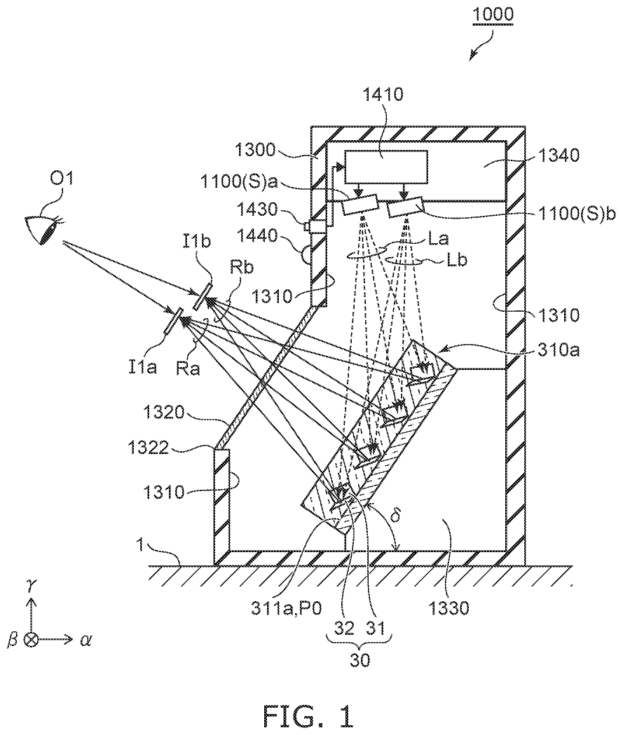

FIG. 1 is a schematic cross-sectional view illustrating an image display device according to a first embodiment.

As shown in FIG. 1, the image display device 1000 according to the embodiment includes an imaging element 310a and multiple display devices 1100(S)a and 1100(S)b. The image display device 1000 further includes a control device 1410 and an imaging part 1430. The image display device 1000 may include camera lighting 1440.

In the image display device 1000 of the example of FIG. 1, the imaging element 310a, the display devices 1100(S)a and 1100(S)b, and the control device 1410 are located inside a housing 1300. The control device 1410 and the display devices 1100(S)a and 1100(S)b are located at the upper portion of the housing 1300 and are located inside a display device mounting part 1340. The imaging element 310a is located on an imaging element mounting part 1330 located at the lower portion inside the housing 1300. An opening that is defined by a window frame 1322 is provided in the housing 1300, and a window member 1320 is located in the window frame 1322 of the housing 1300. The window member 1320 is light-transmissive.

A three-dimensional orthogonal coordinate system may be used when describing the image display device 1000. The three-dimensional orthogonal coordinate system for describing the image display device 1000 is an orthogonal coordinate system including an α-axis, a β-axis, and a γ-axis. A direction parallel to the x-axis may be called a “α-direction,” a direction parallel to the β-axis may be called a “β-direction,” and a direction parallel to the γ-axis may be called a “γ-direction.”

In the example of FIG. 1, the αβ-plane that includes the x-axis and the β-axis is a plane parallel to a plane 1 on which the image display device 1000 is placed. The α-direction is taken as the depth direction of the image display device 1000. The β-direction is taken as the width direction of the image display device 1000. The γ-axis is orthogonal to the αβ-plane, and the γ-direction is taken as the height direction of the image display device 1000.

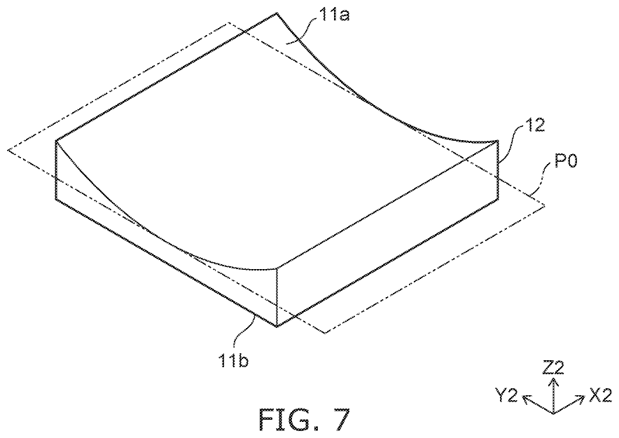

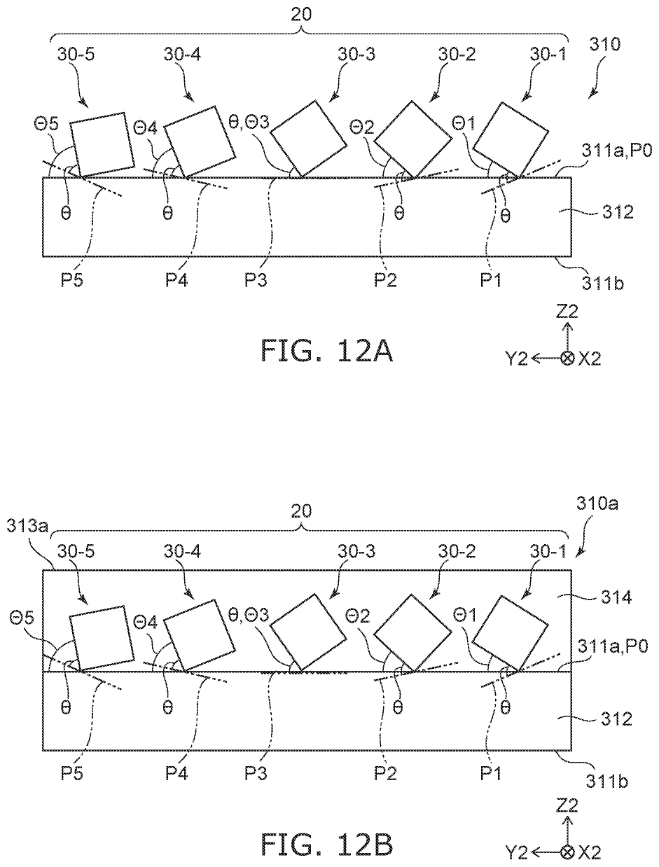

The two display devices 1100(S)a and 1100(S)b are arranged in a plane substantially parallel to the αβ-plane. The two display devices 1100(S)a and 1100(S)b are arranged along the α-direction. The imaging element 310a is located in a plane that is parallel to the β-direction and has an angle δ of not less than 0° from the αβ-plane. The plane at the angle δ is a plane parallel to a virtual plane P0 and a first surface 311a of the imaging element 310a described below with reference to FIGS. 7, 12A, and 12B, and is a surface parallel to the X2Y2-plane. That is, the α-direction (a third direction) crosses the X2Y2-plane at the angle δ.

The display device 1100(S)a is arranged to emit light La toward the imaging element 310a. The display device 1100(S)b is arranged to emit light Lb toward the imaging element 310a.

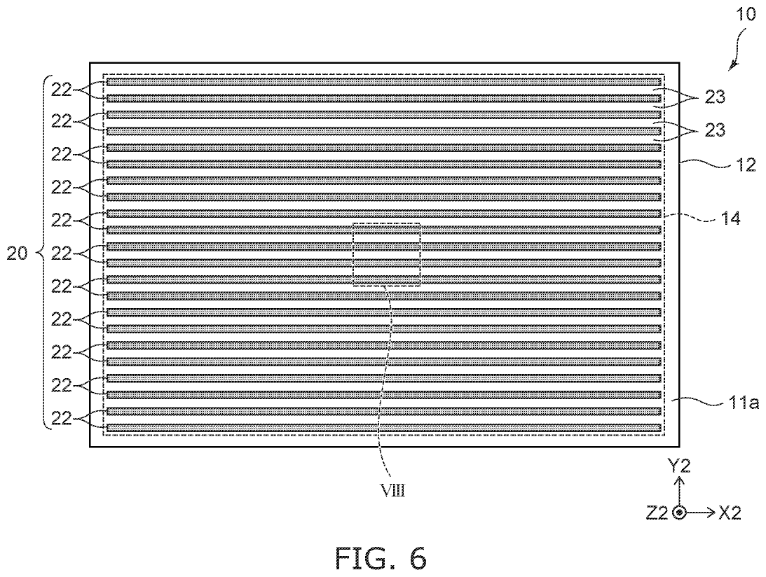

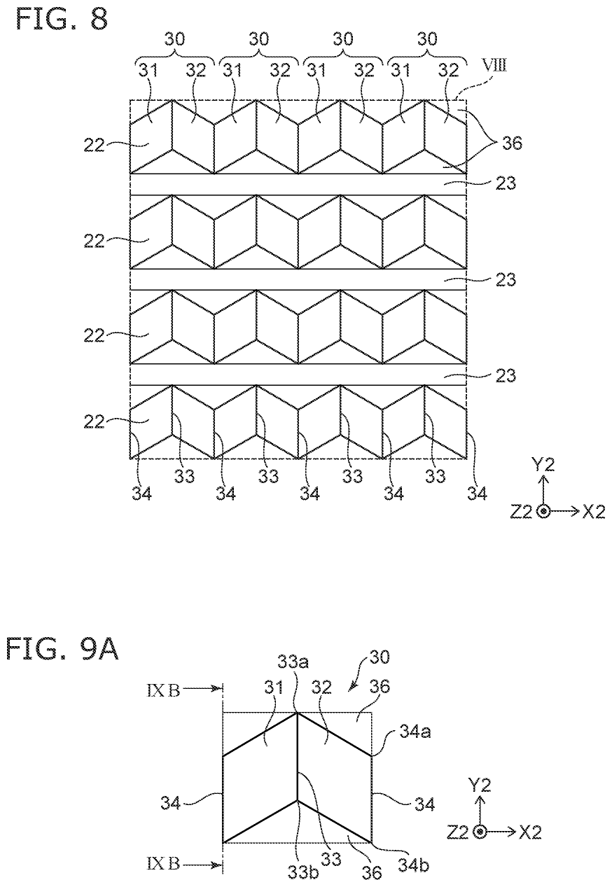

In the imaging element 310a, a reflector row 22, which is elaborated below with reference to FIGS. 6 and 8, extends along a direction orthogonal to the direction in which the display devices 1100(S)a and 1100(S)b are arranged when viewed in top-view; multiple reflector rows 22 are arranged in the X2Y2-plane (described below) along the direction in which the display devices 1100(S)a and 1100(S)b are arranged. That is, when viewed from the γ-direction, the reflector row 22 extends along a direction orthogonal to the α-direction, i.e., the β-direction; the multiple reflector rows are arranged in the X2Y2-plane (described below) along the α-direction.

The imaging element 310a is arranged so that the light La is incident on the imaging element 310a, the imaging element 310a emits a reflected light Ra, the light Lb is incident on the imaging element 310a, and the imaging element 310a emits a reflected light Rb. The angles at which the reflected light Ra and Rb is emitted are in the normal direction of the first surface 311a and the virtual plane P0. That is, the reflected light Ra and Rb is emitted at an angle of substantially 90°−δ from the αβ-plane. The reflected light Ra and Rb that is emitted respectively forms floating images I1a and I1b.

The positions of the display devices 1100(S)a and 1100(S)b, the imaging element 310a, and the floating images I1a and I1b will now be described.

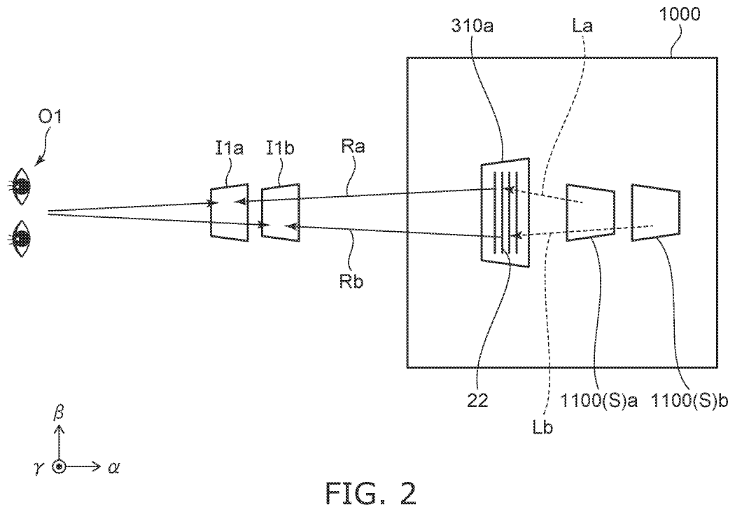

FIG. 2 is a schematic view for describing the positions of the display devices, the imaging element, and the floating images of the image display device according to the first embodiment.

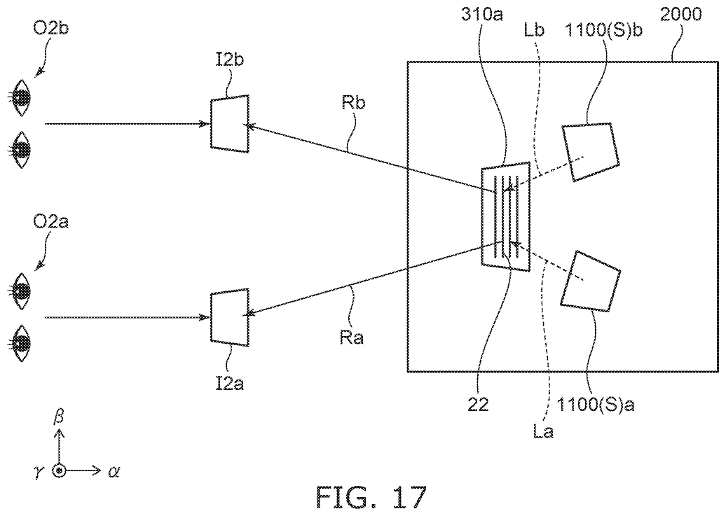

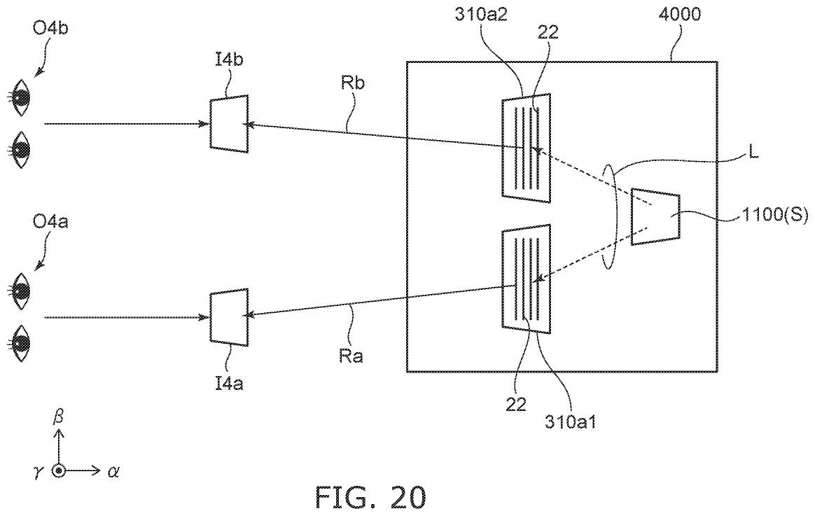

FIG. 2 also shows the position of an observer O1 observing the floating images I1a and I1b displayed by the image display device 1000. FIG. 2 is a schematic view when the image display device 1000, the floating images I1a and I1b, and the observer O1 are viewed from the positive side toward the negative side of the γ-axis. Although the reflector row 22 of the imaging element 310a, which is elaborated with reference to FIGS. 6 to 15, has a width in the α-direction, each reflector row 22 is illustrated by a straight line to avoid complexity of illustration in FIG. 2. This is similar for FIGS. 17 and 20 below.

When the positive direction of the α-axis is taken as the direction from the observer O1 toward the image display device 1000, the display devices 1100(S)a and 1100(S)b are arranged in this order in the positive direction of the α-axis as shown in FIG. 2. The display device 1100(S)a and the imaging element 310a are arranged in the α-direction, and the display device 1100(S)b and the imaging element 310a also are arranged in the α-direction. The imaging element 310a is arranged so that the reflector row 22 is in a direction that is orthogonal to the α-direction and parallel to the β-direction.

The light La that is emitted from the display device 1100(S)a is reflected by the imaging element 310a; and the imaging element 310a emits the reflected light Ra. The reflected light Ra forms the floating image I1a by forming a floating image. The light Lb that is emitted from the display device 1100(S)b is reflected by the imaging element 310a, and the imaging element 310a emits the reflected light Rb. The reflected light Rb forms the floating image I1b by forming a floating image. The floating images I1a and I1b are formed between the image display device 1000 and the observer O1. Because the position of the display device 1100(S)a is more proximate to the observer O1 than the position of the display device 1100(S)b, the position at which the floating image I1a is formed is more proximate to the observer O1 than the position at which the floating image I1b is formed. Because the position of the display device 1100(S)a is further in the −α direction than the position of the display device 1100(S)b, the position at which the floating image I1a is formed is further in the −γ direction than the position at which the floating image I1b is formed.

The floating images I1a and I1b can be formed to be arranged in the α-direction as in the example of FIG. 2 by appropriately setting the positions of the display devices 1100(S)a and 1100(S)b and the angle of the light emission surface from the αβ-plane and by appropriately setting the position of the imaging element 310a and the angle of the first surface 311a from the αβ-plane. The formation positions of the floating images I1a and I1b are not limited thereto and are arbitrarily set. When the formation positions of the floating images I1a and I1b are set so that the floating images do not overlap, the observer O1 can observe two floating images. The two floating images may be the same image or different images. Three or more floating images can be formed at different formation positions by providing three or more display devices.

The description continues now by returning to FIG. 1.

By including the control device 1410 and the imaging part 1430, the image display device 1000 according to the embodiment can form the floating images I1a and I1b at appropriate positions according to the position of the observer O1. More specifically, the imaging part 1430 images the observer O1, generates image data including information of the position of the observer O1, and outputs the image data to the control device 1410. The control device 1410 performs image processing of the image data and detects the position of the observer O1. Based on the detected position of the observer O1, the control device 1410 corrects the positions of the floating images I1a and I1b by adjusting the positions and light emergence angles of the display devices 1100(S)a and 1100(S)b.

When the camera lighting 1440 is included, for example, the camera lighting 1440 is located at a portion of the front of the image display device 1000 to illuminate the observer O1 imaged by the imaging part 1430. By including the camera lighting, the imaging part 1430 can image the observer O1 more clearly, and the control device 1410 can detect the position of the observer O1 more accurately.

By including information of the positions of the eyes and/or pupils of the observer O1 in the image data, the control device 1410 can adjust the positions at which the floating images I1a and I1b are formed according to the positions of the eyes and/or pupils of the observer O1. Thus, the position viewed by the observer O1 can be estimated, and the positions at which the floating images I1a and I1b are formed can be adjusted to be more appropriate positions.

The imaging part 1430 and the camera lighting 1440 are not limited to acquiring the image using visible light, and may acquire the image using, for example, infrared light. The light that forms the floating images I1a and I1b is irradiated on the observer O1 when the observer O1 observes the floating images I1a and I1b. The light that forms the floating images I1a and I1b is irradiated on the observer O1 and may become noise when imaging the observer O1, making it difficult to detect the positions of the eyes and/or pupils of the observer O1. By configuring the imaging part 1430 and the camera lighting 1440 to acquire an image of infrared light, the noise can be removed from the image data, and the positions of the eyes and/or pupils of the observer O1 can be detected more accurately.

The imaging element 310a is arranged on the imaging element mounting part 1330 so that the first surface 311a and the virtual plane P0 are oblique to the bottom surface of the housing 1300. The light La and Lb that is emitted by the display devices 1100(S)a and 1100(S)b is incident on the imaging element 310a, and the imaging element 310a emits the light La and Lb obliquely upward as the reflected light Ra and Rb. The reflected light Ra and Rb is emitted in substantially the normal direction of the first surface 311a and the virtual plane P0. The imaging element 310a is located at the imaging element mounting part 1330 and fixed to the imaging element mounting part 1330, which is provided to support the first surface 311a in the directions in which the reflected light Ra and Rb is emitted. The virtual plane P0 is described below with reference to FIG. 7.

The housing 1300 has any appropriate exterior shape such that the imaging element 310a, the display devices 1100(S)a and 1100(S)b, and the control device 1410 are located at appropriate positions in the interior.

The housing 1300 includes a light-shielding member 1310. In the image display device 1000, the light-shielding member 1310 is a portion of the housing 1300. The light-shielding member 1310 is, for example, a light-absorbing layer located at the interior wall of the housing 1300. The light-absorbing layer is, for example, a coating layer of a black coating material. By providing the light-shielding member 1310 at the interior wall of the housing 1300 in the image display device 1000, a portion of the light emitted from a display device 1100(S) and the imaging element 310a is prevented from being reflected inside the housing 1300 to become stray light. The light-shielding member 1310 is a coating layer of a coating material and is sufficiently thin compared to the thickness of the constituent material of the housing 1300, and is therefore illustrated as the surface of the interior wall of the housing 1300 in FIG. 1.

The window member 1320 is provided in a portion of the housing 1300. The window member 1320 is located at the position of the window frame 1322 which is an opening formed in a portion of the housing 1300. The window frame 1322 is an opening at a position facing the first surface 311a of the imaging element 310a. The window member 1320 is formed of a light-transmitting material such as glass, a transparent resin, etc., so that the imaging element 310a can emit the reflected light Ra and Rb outside the image display device 1000.

The imaging element 310a includes multiple dihedral corner reflectors 30 arranged in a matrix configuration on the first surface 311a. The first surface 311a is arranged to be substantially parallel to the window member 1320 and the opening of the window frame 1322 and the window member 1320. The dihedral corner reflector 30 includes a first reflecting surface 31 and a second reflecting surface 32, the reflecting surfaces reflect the light once each, and the twice-reflected light of the dihedral corner reflector 30 is emitted as the reflected light Ra and Rb. The configuration of the imaging element 310a is described below with reference to FIGS. 6 to 15. The window member 1320 and the window frame 1322 are arranged to transmit the twice-reflected light of the imaging element 310a.

In the image display device 1000, the display device 1100(S) and the imaging element 310a are arranged to form the images I1a and I1b substantially directly above the imaging element 310a. “Directly above the imaging element 310a” is a position in the normal direction of the first surface 311a. In such an arrangement, there are cases where the imaging element 310a also emits a portion of the once-reflected light toward the first surface 311a side and forms false images and/or ghosts at the first surface 311a side. According to the configuration of the imaging element 310a, there are also cases where light that is not reflected by any reflecting surface is emitted toward the first surface 311a side. Accordingly, the light-shielding member 1310 is located at the interior wall of the housing 1300 at positions that shield at least the leakage light from the display device 1100(S) and the light other than the twice-reflected light of the imaging element 310a.

The reflected light Ra and Rb that is emitted from the imaging element 310a is transmitted by the window member 1320 and respectively forms the images I1a and I1b outside the housing 1300. The window member 1320 is located between the imaging element 310a and the positions at which the images I1a and I1b are formed. When the observer O1 is present, the images I1a and I1b are formed between the observer O1 and the window member 1320.

Although the light-shielding member 1310 is located at the interior wall of the housing 1300 in the specific example above, the light-shielding member 1310 is not limited to being located at the interior wall as long as the leakage light radiated from the display device 1100(S) and/or the imaging element 310a can be shielded. For example, the leakage light from the display device 1100(S) can be shielded by surrounding the periphery of the display device 1100(S) with a tubular body coated in black. The light other than the twice-reflected light of the imaging element 310a can be shielded by forming the base member of the imaging element 310a from a black resin, etc.

The configuration of the display device 1100(S) will now be described in detail.

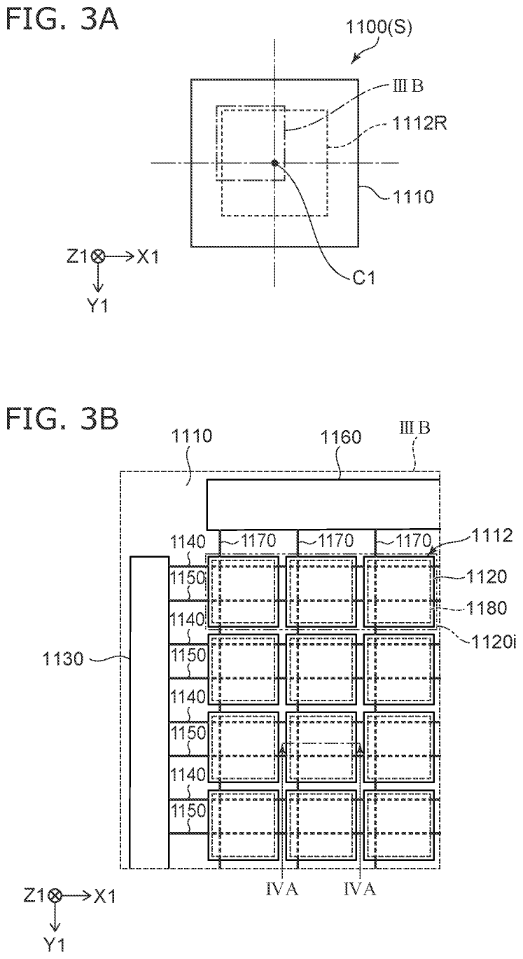

FIG. 3A is a schematic plan view illustrating a portion, i.e., the display device, of the image display device according to the first embodiment.

FIG. 3B is an enlarged schematic view of portion IIIB of FIG. 3A.

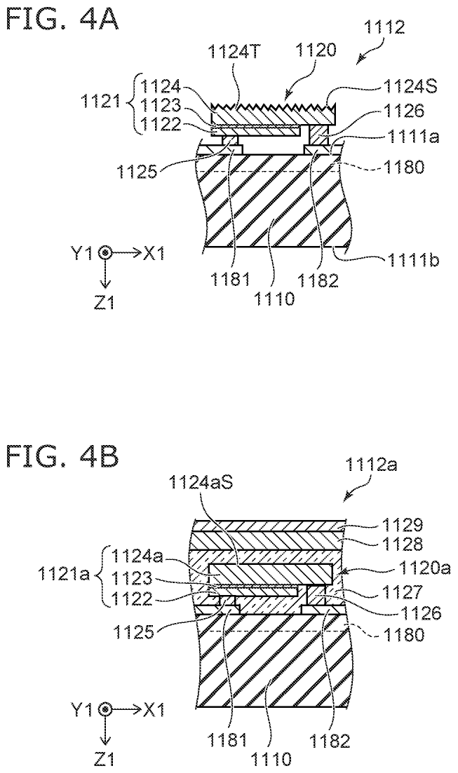

FIG. 4A is a schematic auxiliary cross-sectional view along line IVA-IVA of FIG. 3B.

The multiple display devices 1100(S)a and 1100(S)b shown in FIG. 1 include the same configuration. When describing the configuration of the display device with reference to FIGS. 3A to 5, the display devices 1100(S)a and 1100(S)b are described as the display device 1100(S).

A three-dimensional orthogonal coordinate system may be used in the description of the display device 1100(S). The three-dimensional orthogonal coordinate system for the description of the display device 1100(S) is an orthogonal coordinate system including an X1-axis, a Y1-axis, and a Z1-axis. A direction parallel to the X1-axis may be called an “X1-direction,” a direction parallel to the Y1-axis may be called a “Y1-direction,” and a direction parallel to the Z1-axis may be called a “Z1-direction.” The X1Y1-plane that includes the X1-axis and the Y1-axis is parallel to a first surface 1111a of the substrate of the display device 1100(S). The first surface 1111a is a surface at which the LED elements are arranged and a pixel formation region 1112R is located. The X1-axis is parallel to the rows of pixels of the display device 1100(S). The Y1-axis is orthogonal to the X1-axis. The Z1-axis is orthogonal to the X1-axis and the Y1-axis and is the positive direction from the first surface 1111a toward a second surface 1111b. The second surface 1111b is positioned at the side opposite to the first surface 1111a of a substrate 1110.

According to the X1Y1Z1-orthogonal coordinate system, the display device 1100(S) emits light mainly in the negative direction of the Z1-axis. As shown in FIG. 1, the imaging element 310a is located at the side at which the display device 1100(S) emits light. That is, the imaging element 310a is located at the negative Z1-axis side of the display device 1100(S).

As shown in FIG. 3A, the display device 1100(S) includes the substrate 1110 that is substantially rectangular when the X1Y1-plane is viewed in plan. The substrate 1110 can be, for example, glass, a resin such as polyimide or the like, or a Si substrate may be used. In the display device 1100(S), an optical axis C1 is aligned with the center of the shape of the outer perimeter of the substrate 1110 when the X1Y1-plane is viewed in plan. The optical axis C1 is parallel to the Z1-axis. By aligning the optical axis C1 with the Z1-axis, the display device 1100(S) can be rotated around the optical axis C1 by six-axis control.

The pixel formation region 1112R is located on the substrate 1110 with the optical axis C1 at the center. Pixels 1112 shown in FIG. 3B are arranged in a matrix configuration in the pixel formation region 1112R. Although the pixel formation region 1112R is substantially square in the example shown in FIG. 3A, the pixel formation region 1112R can have any shape. That is, the outer perimeter formed by the arrangement of the pixels 1112 can have any shape.

As shown in FIG. 3B, the display device 1100(S) includes the multiple pixels 1112 as a light source. The display device 1100(S) uses the multiple pixels 1112 to display the desired image. The display device 1100(S) is electrically connected to the control device 1410. The display controller 1416 supplies, to the display device 1100(S), data related to the image displayed by the display device 1100(S). The display device 1100(S) displays a still image, a video image, etc., based on the data related to the image supplied from the display controller 1416.

The display device 1100(S) includes the substrate 1110, the multiple pixels 1112, a scanning circuit 1130, multiple scanning lines 1140, multiple lighting control lines 1150, a drive circuit 1160, and multiple signal lines 1170. The pixel 1112 includes LED elements 1120 and individual circuits 1180. The LED elements 1120, the scanning circuit 1130, the drive circuit 1160, and the individual circuits 1180 are shown simply as quadrilaterals to avoid complexity in the illustration of FIG. 3B.

The multiple LED elements 1120 are arranged in a matrix configuration. Hereinbelow, the multiple LED elements 1120 arranged in one row in the X1-direction are called the “row 1120i”.

As shown in FIG. 4A, the substrate 1110 includes the first surface 1111a and the second surface 1111b. The second surface 1111b is at the side opposite to the first surface 1111a. The LED elements 1120 are arranged in a matrix configuration on the first surface 1111a. The LED elements 1120 are mounted face-down on the first surface 1111a. The LED elements are not limited to face-down mounting and may be mounted face-up on the first surface 1111a.

The LED element 1120 includes a semiconductor stacked body 1121, an anode electrode 1125, and a cathode electrode 1126. The semiconductor stacked body 1121 includes a p-type semiconductor layer 1122, an active layer 1123 located on the p-type semiconductor layer 1122, and an n-type semiconductor layer 1124 located on the active layer 1123. The semiconductor stacked body 1121 includes, for example, a gallium nitride compound semiconductor of In_{X}Al_{Y}Ga_{1-X-Y}N (0≤X, 0≤Y, and X+Y<1). According to the embodiment, the light that is emitted by the LED element 1120 is visible light.

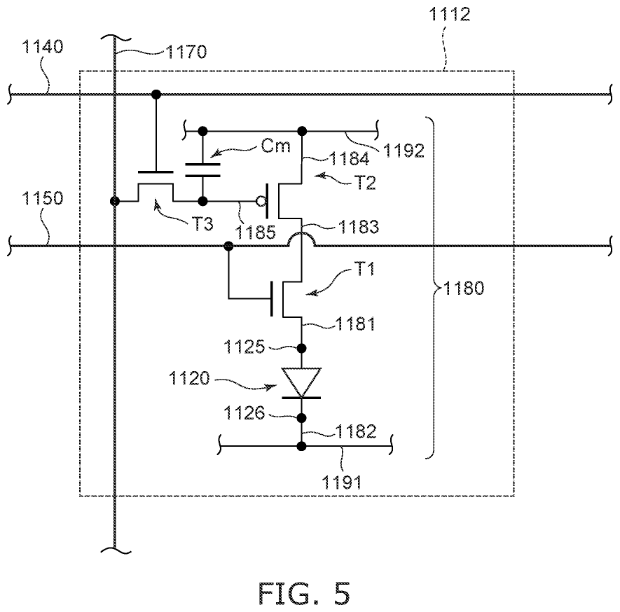

The anode electrode 1125 is electrically connected to the p-type semiconductor layer 1122. The anode electrode 1125 also is electrically connected to a wiring part 1181 of the individual circuit 1180 described below with reference to FIG. 5. In the example shown in FIGS. 4A and 4B, the individual circuit 1180 is formed in a Si substrate. The cathode electrode 1126 is electrically connected to the n-type semiconductor layer 1124. The cathode electrode 1126 also is electrically connected to another wiring part 1182 of the individual circuit 1180. The anode electrode 1125 and the cathode electrode 1126 can include, for example, metal materials.

In the example shown in FIG. 4A, multiple recesses 1124T are provided in a light-emitting surface 1124S of the LED element 1120. Hereinbelow, “the light-emitting surface of the LED element” means the surface of the LED element from which the light is mainly emitted. In the example shown in FIG. 4A, the light-emitting surface 1124S is one surface of the n-type semiconductor layer 1124. More specifically, the light-emitting surface 1124S is positioned at the side of the n-type semiconductor layer 1124 opposite to the surface facing the active layer 1123.

Methods of forming the multiple recesses 1124T in the light-emitting surface 1124S include a method in which an n-type semiconductor layer is grown on a growth substrate in which protrusions are formed, a method in which surface roughening of the surface of the n-type semiconductor layer is performed by anisotropic etching, etc. The growth substrate may be detached at the prescribed timing.

Thus, the LED element 1120 can emit light having a larger light distribution angle because the multiple recesses 1124T are provided in the light-emitting surface 1124S of the LED element 1120.

The configuration of the LED element is not limited to the configuration described above. For example, multiple protrusions instead of multiple recesses may be provided in the light-emitting surface of the LED element, or both multiple recesses and multiple protrusions may be provided. When the growth substrate is light-transmissive, the growth substrate may not be detached from the semiconductor stacked body; at least one of multiple recesses or multiple protrusions may be provided in the surface of the growth substrate corresponding to the light-emitting surface.

The structure of the display device 1100(S) is not limited to the structure described above. Although the LED elements 1120 are individually mounted on the substrate 1110 in which the individual circuits 1180 are provided in the example above, the LED elements 1120 may be individually patterned from a semiconductor stacked body bonded on the substrate 1110 in which the individual circuits 1180 are provided, and then wired.

FIG. 4B is a schematic cross-sectional view illustrating a portion, i.e., a modification of the display device, of the image display device according to the first embodiment.

FIG. 4B corresponds to an auxiliary cross-sectional view along line IVA-IVA of FIG. 3B, and is an auxiliary cross-sectional view at the same position as the position shown in FIG. 4A.

As shown in FIG. 4B, a pixel 1112a includes an LED element 1120a and a wavelength conversion member 1128. Similarly to the pixel 1112 shown in FIG. 3B, the pixel 1112a includes the individual circuit 1180. As in the example shown in FIG. 4B, the pixel 1112a may further include a color filter 1129.

According to the modification, the LED element 1120a includes a semiconductor stacked body 1121a, the anode electrode 1125, and the cathode electrode 1126. The semiconductor stacked body 1121a includes the p-type semiconductor layer 1122, the active layer 1123, and an n-type semiconductor layer 1124a. The active layer 1123 is located on the p-type semiconductor layer 1122, and the n-type semiconductor layer 1124a is located on the active layer 1123. The n-type semiconductor layer 1124a includes a light-emitting surface 1124aS. The light-emitting surface 1124aS is a flat surface that does not include recesses or protrusions.

In the pixel 1112a, a protective layer 1127 covers the LED element 1120a, the wiring parts 1181 and 1182, and the first surface 1111a of the substrate 1110. The protective layer 1127 can include, for example, a light-transmitting material such as a polymer material including a sulfur (S)-including substituent group or phosphorus (P) atom-including group, a high refractive index nanocomposite material in which high refractive index inorganic nanoparticles are introduced to a polymer matrix of polyimide, etc.

The wavelength conversion member 1128 is located on the protective layer 1127. The wavelength conversion member 1128 includes at least one type of wavelength conversion material such as a general fluorescer material, a perovskite fluorescer material, a quantum dot (QD), etc. The light that is emitted from the LED element 1120a is incident on the wavelength conversion member 1128. The wavelength conversion material that is included in the wavelength conversion member 1128 converts the light into light of a different peak wavelength from the light emitted from the LED element 1120a, and emits the light. The light that is incident on the wavelength conversion member 1128 is scattered inside the wavelength conversion member 1128; therefore, the light that is emitted by the wavelength conversion member 1128 is emitted with a wider light distribution angle.

The color filter 1129 is located on the wavelength conversion member 1128. The color filter 1129 can shield the greater part of the light that is emitted from the LED element 1120a but does not undergo wavelength conversion by the wavelength conversion member 1128. As a result, the light that is emitted by the wavelength conversion member 1128 is the main light emitted from the pixel 1112a.

According to the modification, the light emission peak wavelength of the LED element 1120a may be in the ultraviolet region or the visible light region. When blue light is to be emitted from at least one pixel 1112a, blue light may be emitted from the LED element 1120a belonging to the pixel 1112a without providing the wavelength conversion member 1128 and the color filter 1129 in the pixel 1112a.

In the LED element, an n-type semiconductor layer may be arranged to face a substrate, an active layer and a p-type semiconductor layer may be stacked in this order on the n-type semiconductor layer, and the surface of the p-type semiconductor layer at the side opposite to the surface facing the active layer may be used as the light-emitting surface of the LED element.

As shown in FIG. 3B, for example, the scanning circuit 1130 is provided in the substrate 1110 to be adjacent to the multiple LED elements 1120, which are arranged in a matrix configuration, in the X1-direction when viewed in plan. That is, the scanning circuit 1130 is located adjacent to the outer edge parallel to the X1-direction of the pixel formation region 1112R shown in FIG. 2. The scanning circuit 1130 is configured to sequentially switch, in the Y1-direction, the row 1120i that is driven. The multiple scanning lines 1140 extend in the X1-direction from the scanning circuit 1130. The multiple lighting control lines 1150 extend in the X1-direction from the scanning circuit 1130. The multiple scanning lines 1140 and the multiple lighting control lines 1150 are alternately arranged in the Y1-direction.

The drive circuit 1160 is provided in the substrate 1110 to be adjacent to the multiple LED elements 1120, which are arranged in a matrix configuration, in the Y1-direction when the X1Y1-plane is viewed in plan. That is, the drive circuit 1160 is located adjacent to the outer edge parallel to the Y1-direction of the pixel formation region 1112R shown in FIG. 3A. The drive circuit 1160 is configured to control the outputs of the LED elements 1120 belonging to the row 1120i that is driven. The multiple signal lines 1170 extend in the Y1-direction from the drive circuit 1160. The multiple signal lines 1170 are arranged in the X1-direction. The drive circuit 1160 may include an IC chip, and the IC chip may be mounted on the substrate 1110.

For example, the scanning circuit 1130, the multiple scanning lines 1140, the multiple lighting control lines 1150, the drive circuit 1160, the multiple signal lines 1170, and the individual circuits 1180 may be formed on the substrate 1110 by a low-temperature polysilicon (LTPS) process.

In the example, one pixel 1112 includes one individual circuit 1180 and one LED element 1120. Multiple LED elements 1120 may be included in one pixel 1112. When multiple LED elements 1120 are included in one pixel 1112, one individual circuit may correspond to multiple LED elements. Alternatively, the individual circuits 1180 may be provided for each LED element 1120 in one pixel 1112.

FIG. 5 is a schematic equivalent circuit diagram illustrating a portion, i.e., the display device, of the image display device according to the first embodiment.

As shown in FIG. 5, the individual circuit 1180 includes a first transistor T1, a second transistor T2, a third transistor T3, a capacitor Cm, and multiple wiring parts 1181 to 1185. The first transistor T1 and the third transistor T3 are n-channel MOSFETs. The second transistor T2 is a p-channel MOSFET.

The cathode electrode 1126 of the LED element 1120 is electrically connected to a ground line 1191 via the wiring part 1182. For example, a voltage that is used as a reference is applied to the ground line 1191. The anode electrode 1125 of the LED element 1120 is electrically connected to the source electrode of the first transistor T1 via the wiring part 1181.

The gate electrode of the first transistor T1 is electrically connected to the lighting control line 1150. The drain electrode of the first transistor T1 is electrically connected to the drain electrode of the second transistor T2 via a wiring part 1183. The source electrode of the second transistor T2 is electrically connected to a power supply line 1192 via a wiring part 1184. A sufficiently higher voltage than the voltage used as the reference is applied to the power supply line 1192. Although not illustrated, a DC power supply is connected to the power supply line 1192 and the ground line 1191; a positive DC voltage with respect to the reference voltage applied to the ground line 1191 is applied between the power supply line 1192 and the ground line 1191.

The gate electrode of the second transistor T2 is electrically connected to the drain electrode of the third transistor T3 via the wiring part 1185. The source electrode of the third transistor T3 is electrically connected to the signal line 1170. The gate electrode of the third transistor T3 is electrically connected to the scanning line 1140.

The wiring part 1185 is electrically connected to one terminal of the capacitor Cm. The other terminal of the capacitor Cm is electrically connected to the power supply line 1192.

The scanning circuit 1130 selects one row among the multiple rows 1120i and outputs an on-signal to the scanning line 1140 electrically connected to the row 1120i. As a result, the third transistors T3 of the individual circuits 1180 corresponding to the row 1120i are in a state in which the third transistors T3 can be switched on. The drive circuit 1160 outputs, to the signal lines 1170, drive signals including drive signal voltages corresponding to the set outputs of the LED elements 1120 belonging to the row 1120i. As a result, the drive signal voltages are stored in the capacitors Cm. The drive signal voltages set the second transistors T2 of the individual circuits 1180 corresponding to the row 1120i to a state in which the second transistor T2 can be switched on.

The scanning circuit 1130 outputs, to the lighting control line 1150 electrically connected to the row 1120i, a control signal that sequentially switches the first transistors T1 of the row 1120i on and off. When the first transistors T1 are in the on-state, the light emission luminances of the LED elements 1120 are controlled by currents corresponding to the drive signal voltages stored in the capacitors Cm flowing in the LED elements 1120 belonging to the row 1120i. The light emission periods of the LED elements 1120 are controlled for each row 1120i by switching the first transistors T1 on and off.

The scanning circuit 1130 sequentially switches, in the Y1-direction, the scanning line 1140 outputting the on-signal and the lighting control line 1150 outputting the control signal. Accordingly, the row 1120i that is driven is sequentially switched in the Y1-direction.

The configurations of the scanning circuit, the multiple scanning lines, the multiple lighting control lines, the drive circuit, the multiple signal lines, the multiple individual circuits, etc., are not limited to those described above. For example, the individual circuit may be made of a second transistor, a third transistor, a capacitor, and wiring parts without including a first transistor; multiple scanning lines may extend from the scanning circuit, and a lighting control line may be omitted. The scanning lines, the lighting control lines, the signal lines, the wiring parts of the individual circuits, etc., may not be on the surface of the substrate, and may be provided in the substrate. The electrical elements such as the transistors, capacitors, and the like included in the drive circuit may be separately manufactured and then mounted on the substrate instead of being formed on the substrate. Instead of separately manufacturing the LED elements and then mounting to the substrate, the LED elements may be formed on the substrate by using a semiconductor material such as Si or the like as the substrate. In such a case, each transistor element may be a silicon semiconductor element provided on the silicon substrate instead of a low-temperature polysilicon element provided on the glass substrate.

The display device that includes the LED element as described above is favorable in that a sufficient light emission luminance is realized with low power consumption; however, the display device is not limited thereto. Instead of an LED display using an LED element such as that described above, the display device may be an OLED display, a liquid crystal display, etc.

A configuration of the imaging element 310a will now be described in detail.

FIG. 6 is a schematic plan view illustrating a portion, i.e., the imaging element, of the image display device.

As shown in FIG. 1, the image display device 1000 according to the embodiment includes the imaging element 310a. The imaging element 310a shown in FIG. 1 is one of many variations of imaging element configurations. The following description includes the operation principle of the imaging element forming the floating image in mid-air. First, the configuration and operation of an imaging element 10 will be described.

As shown in FIG. 6, the imaging element 10 includes a base member 12 and a reflector array 20. The base member 12 includes a first surface 11a, and the reflector array 20 is provided on the first surface 11a. In the example shown in FIG. 6, the reflector array 20 is provided inside a reflector formation region 14 of the first surface 11a. The reflector array 20 includes multiple reflector rows 22. The reflector array 20 may be provided in the base member 12. That is, the reflector array 20 and the base member 12 may be formed as a continuous body. In such a case, the first surface 11a of the base member 12 is the dihedral corner reflectors of the reflector array 20 described below.

A configuration of the base member 12 will now be described.

FIG. 7 is a schematic perspective view illustrating a portion, i.e., the base member, of the imaging element of FIG. 6.

As shown in FIG. 7, the base member 12 includes the first surface 11a and a second surface 11b. The second surface 11b is positioned at the side opposite to the first surface 11a.

The three-dimensional orthogonal coordinate system used in the description of the imaging element may be different from the three-dimensional orthogonal coordinate system of the description of the display device 1100(S) shown in FIG. 3A, etc. The three-dimensional orthogonal coordinate system for the description of the imaging element is an orthogonal coordinate system including an X2-axis, a Y2-axis, and a Z2-axis. A direction parallel to the X2-axis may be called the “X2-direction,” a direction parallel to the Y2-axis may be called the “Y2-direction,” and a direction parallel to the Z2-axis may be called the “Z2-direction.” The X2Y2-plane that includes the X2-axis and the Y2-axis is defined as a plane parallel to the virtual plane P0. The first surface 11a is located at the positive Z2-axis side of the second surface 11b. The first surface 11a includes a portion of a circular arc that is convex toward the negative Z2-axis side when the Y2Z2-plane is viewed in plan. In the specific example below, the virtual plane P0 is a virtual surface parallel to a tangent plane contacting a point on the circular arc positioned furthest in the negative direction of the Z2-axis.

As described above, the first surface 11a is a curved surface, and the reflector array 20 is located on the curved surface. The virtual plane P0 is used as a reference surface when setting the tilt in the Y2-axial direction of the reflector row 22. In other words, the reflector row 22 is arranged on the first surface 11a at an angle set with respect to the virtual plane P0.

The base member 12 is formed of a light-transmitting material and is formed of, for example, a transparent resin.

In the imaging element 10, when the light source is located at the first surface 11a side when referenced to the base member 12, the floating image is formed not at the second surface 11b side, but at the first surface 11a side at which the light source is located. The position at which the floating image is formed can be different from the position at which the light source is located and sufficiently separated from the position at which the light source is located.

The description continues now by returning to FIG. 6.

The reflector row 22 extends along the X2-direction (the first direction). The multiple reflector rows 22 are arranged to be substantially parallel to each other along the Y2-direction (a second direction). The multiple reflector rows 22 are arranged at substantially uniform spacing with a spacing 23 interposed in the Y2-direction respectively between the adjacent reflector rows 22. The length in the Y2-direction of the spacing 23 of the reflector rows 22 can be any length and can be, for example, about the length in the Y2-direction of the reflector row 22. When the light source is located at the first surface 11a side, light rays that are not reflected by the reflector rows 22, reflected light that is reflected once by the reflector row 22, and the like are incident on the region in which the spacing 23 of the reflector rows 22 is formed. Such light rays do not contribute to the floating image; therefore, the ratio of the light rays incident on the imaging element 10 that contribute to the floating image decrease as the spacing 23 increases. Therefore, the length in the Y2-direction of the spacing 23 is set to an appropriate length according to the efficiency of the reflecting surfaces, the dimensions of the dihedral corner reflector described below with reference to FIG. 8, etc.

Each of the reflector rows 22 includes many dihedral corner reflectors connected in the X2-direction and is therefore shown as filled-in to avoid complexity in FIG. 6. In the example shown in FIG. 6, the imaging element 10 has a laterally-long shape in the X2-direction. This is because the shape is advantageous for binocular viewing of the floating image. The shape of the imaging element 10 when the X2Y2-plane is viewed in plan is not limited thereto, and a longitudinally-long shape in the Y2-direction may be selected according to the application.

When an image is formed in the normal direction of the first surface 311a of the imaging element 310a as in the image display device 1000 shown in FIG. 1, the spacing of the adjacent reflector rows 22 may not be provided. When the spacing of the adjacent reflector rows 22 is provided, the spacing of the reflector rows may be a reflecting surface.

FIG. 8 is an enlarged schematic view of portion VIII of FIG. 6.

As shown in FIG. 8, the reflector row 22 includes the multiple dihedral corner reflectors 30. The multiple dihedral corner reflectors 30 are connected to each other along the X2-direction and are provided continuously. The dihedral corner reflector 30 includes the first reflecting surface 31 and the second reflecting surface 32. The dihedral corner reflector 30 is located on a base part 36 formed on the first surface 11a shown in FIG. 6. The first reflecting surface 31 and the second reflecting surface 32 each are substantially square when viewed in front-view, and the reflecting surfaces are connected to each other at one side of each of the squares so that the reflecting surfaces are substantially orthogonal to the orientation of the valley.

Hereinbelow, the connecting line between the first and second reflecting surfaces 31 and 32 of the dihedral corner reflector 30 is called a valley-side connecting line 33. The side of the first reflecting surface 31 positioned at the side opposite to the valley-side connecting line 33 and the side of the second reflecting surface 32 positioned at the side opposite to the valley-side connecting line 33 each are called hill-side connecting lines 34.

The first reflecting surface 31 of the dihedral corner reflector 30 is connected at the hill-side connecting line 34 to the second reflecting surface 32 of the dihedral corner reflector 30 adjacent at the negative X2-axis side. The second reflecting surface 32 of the dihedral corner reflector 30 is connected at the hill-side connecting line 34 to the first reflecting surface 31 of another dihedral corner reflector 30 adjacent at the positive X2-axis side. Thus, the multiple dihedral corner reflectors 30 are connected to each other along the X2-direction and are provided continuously.

In the imaging element 10 of the embodiment, the dimensions of the first and second reflecting surfaces 31 and 32 can be, for example, several mm to several hundred mm. For example, the number of integrated dihedral corner reflectors 30 is set according to the size, resolution, and the like of the image to be displayed. For example, several tens to several thousand dihedral corner reflectors 30 are integrated in one imaging element 10. For example, one thousand dihedral corner reflectors including 100 mm-square reflecting surfaces can be arranged over about 14 cm in the Y2-direction.

As in the enlarged view shown in FIG. 8, the reflector rows 22 of the imaging element 10 are arranged so that the positions in the X2-axial direction of the valley-side connecting line 33 and the hill-side connecting line 34 are respectively the same. This arrangement is not limited thereto; the positions in the X2-axial direction of the valley-side connecting line 33 and the hill-side connecting line 34 may be shifted between the reflector rows 22.

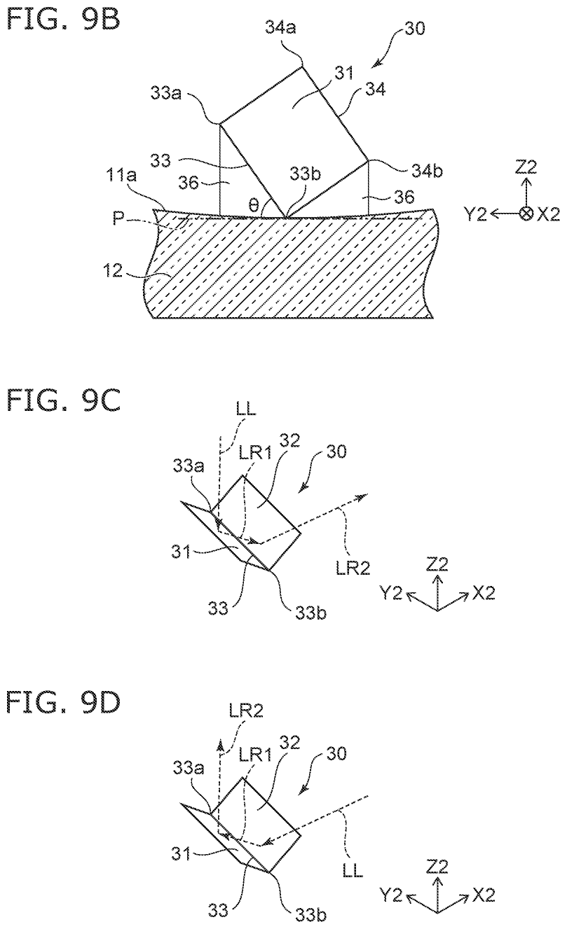

FIG. 9A is a schematic plan view illustrating a portion, i.e., the dihedral corner reflector, of the imaging element of FIG. 8.

FIG. 9B is an example of a schematic auxiliary cross-sectional view along line IXB-IXB of FIG. 9A.

As shown in FIGS. 9A and 9B, the dihedral corner reflector 30 includes the first reflecting surface 31 and the second reflecting surface 32, and the first reflecting surface 31 and the second reflecting surface 32 are located on the base part 36. The base part 36 is arranged so that the first reflecting surface 31 and the second reflecting surface 32 have the desired angle with respect to a tangent plane P of the first surface 11a.

The base part 36 is a light-transmitting member formed in a V-shape, is formed of, for example, a transparent resin, and is formed as a continuous body with the base member 12. The first reflecting surface 31 and the second reflecting surface 32 are formed by thin film formation of a light-reflective metal material or the like at the formation location of the V-shape of the base member 12. The formation is not limited to such an example; each or a portion of the first reflecting surface 31, the second reflecting surface 32, the base part 36, and the base member 12 may be formed separately, and assembled as one to form the imaging element 10. For example, mirror finishing or the like of the surface of the transparent resin is performed, and the first reflecting surface 31 and the second reflecting surface 32 can be used as-is as the surface of the transparent resin when the surface reflectance of the transparent resin is sufficiently high. It is favorable for the spacing 23 and/or the base part 36 to be light-transmissive or light-absorbing to prevent false image observation, etc.

The dihedral corner reflector 30 may be formed as follows. The first reflecting surface 31 and the second reflecting surface 32 are formed in the surface of the transparent resin. The first reflecting surface 31 and the second reflecting surface 32 that are formed are exposed in air and arranged so that light incident from the surface opposite to the surface at which the first reflecting surface 31 and the second reflecting surface 32 are formed. As a result, the first reflecting surface 31 and the second reflecting surface 32 can function as total reflection surfaces due to the refractive index difference between the transparent resin and the air.

The first reflecting surface 31 and the second reflecting surface 32 are connected at the valley-side connecting line 33 to be substantially orthogonal. The hill-side connecting line 34 of the first reflecting surface 31 is positioned at the side opposite to the valley-side connecting line 33, and the hill-side connecting line 34 of the second reflecting surface 32 is positioned at the side opposite to the valley-side connecting line 33.

The end portions of the valley-side connecting line 33 are called vertices 33a and 33b. The position of the vertex 33a is further toward the positive Z2-axis side than the position of the vertex 33b. That is, the vertex 33a is positioned to be more distal to the base member 12 than the vertex 33b. The end portions of the hill-side connecting line 34 are called vertices 34a and 34b. The position of the vertex 34a is further toward the positive Z2-axis side than the position of the vertex 34b. That is, the vertex 34a is positioned to be more distal to the base member 12 than the vertex 34b. Accordingly, the vertex 34a is positioned to be furthest from the base member 12, and the vertex 33b is positioned to be most proximate to the base member 12.

FIG. 9B shows the relationship between the dihedral corner reflector 30, the first surface 11a, and the tangent plane P. The dihedral corner reflector 30 contacts the first surface 11a at the vertex 33b at the lower side of the valley-side connecting line 33. The tangent plane P contacts the first surface 11a at the position of the vertex 33b. The dihedral corner reflector 30 is located on the first surface 11a so that the valley-side connecting line 33 forms an angle θ with the tangent plane P.

FIGS. 9C and 9D are schematic perspective views for describing the operation of the dihedral corner reflector of FIG. 9A.

As shown in FIG. 9C, when a light ray LL is incident on the first reflecting surface 31, the light ray LL is reflected by the first reflecting surface 31. A once-reflected light LR1 that is reflected by the first reflecting surface 31 is re-reflected by the second reflecting surface 32. A twice-reflected light LR2 that is reflected by the second reflecting surface 32 is emitted toward the same side as the light source of the incident light. Thus, the dihedral corner reflector 30 emits the incident light from the first surface 11a side toward a different position from the light source at the first surface 11a side. Thus, the dihedral corner reflector 30 reflects the light twice by two reflecting surfaces, and reflects the twice-reflected light LR2 toward the side from which the incident light ray LL traveled.

The reflection operation of the dihedral corner reflector 30 is reversible. When the light ray that is incident on the dihedral corner reflector 30 is incident along the opposite direction along the twice-reflected light LR2 in FIG. 9C, the light ray is reflected in the opposite direction along the incident light ray LL. Specifically, as shown in FIG. 9D, the light ray LL that is incident on the dihedral corner reflector 30 is reflected by the second reflecting surface 32 and incident on the first reflecting surface 31 as the once-reflected light LR1. The once-reflected light LR1 is reflected by the first reflecting surface 31 and emitted as the twice-reflected light LR2.

As shown in FIGS. 8 and 9A, the dihedral corner reflector 30 is line-symmetric with respect to the valley-side connecting line 33, and is positioned so that the angle of the first reflecting surface 31 with respect to the tangent plane P is substantially equal to the angle of the second reflecting surface 32 with respect to the tangent plane P. Therefore, when the light ray is initially incident on the first reflecting surface 31, the dihedral corner reflector 30 emits the reflected light by an operation similar to when the light ray is initially incident on the second reflecting surface 32. For example, in FIG. 9C, the light ray LL is initially incident on the first reflecting surface 31 and reflected by the first reflecting surface 31; however, the operation of the dihedral corner reflector 30 can be similar to the description described above even when the light ray LL is initially incident on the second reflecting surface 32 and reflected by the second reflecting surface 32. In FIG. 9D, the light ray LL may be initially incident on the first reflecting surface 31, and the once-reflected light from the first reflecting surface 31 may be reflected by the second reflecting surface 32 and emitted as the second reflected light. Unless otherwise noted in the description of the operation of the imaging element hereinbelow, the case where the light ray LL is initially reflected by the first reflecting surface 31 will be described.

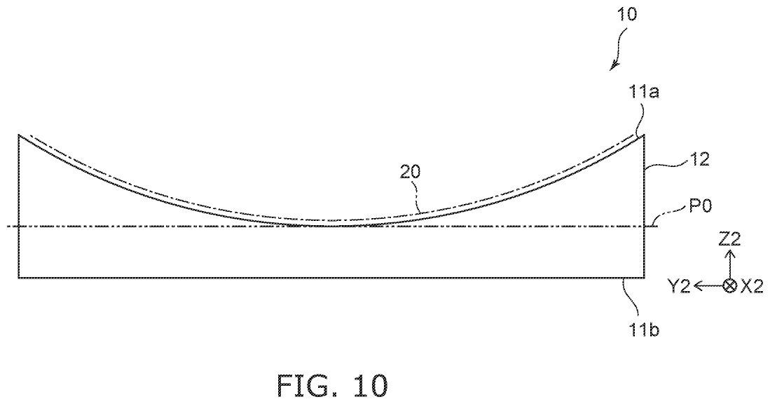

FIG. 10 is a schematic side view illustrating the imaging element of FIG. 6.

In FIG. 10, the reflector array 20 is shown by an envelope connecting the vertices 33a of the dihedral corner reflectors 30 shown in FIGS. 9A and 9B. In side views illustrating the imaging element hereinbelow, the reflector array 20 is illustrated by illustrating the envelope of the vertices 33a of the dihedral corner reflectors 30 as a single dot-dash line as shown in FIG. 10 unless it is necessary to show and describe the configuration of the dihedral corner reflector 30.

In the imaging element 10 as shown in FIG. 10, the reflector array 20 is provided in a curved shape because the first surface 11a is a curved surface. The first surface 11a includes a portion of a circular arc that is convex toward the negative Z2-axis side when the Y2Z2-plane is viewed in plan, the reflector array 20 also is provided in an arc-like shape, and the envelope of the vertices also is a circular arc. The radius of the circular arc is set based on the distance between the imaging element 10 and the light source provided at the first surface 11a side of the imaging element 10. For example, the radius of the circular arc of the reflector array 20 is set to about 2 times the distance between the imaging element 10 and the light source.

As described with reference to FIGS. 9C and 9D, the imaging element 10 is reversible with respect to the incidence and reflection directions of the light ray. When the incidence and reflection directions of the imaging element 10 are reversed, the radius of the circular arc is set based on the distance between the imaging element 10 and the floating image formed at the first surface 11a side. Similarly to the description described above, the radius of the circular arc of the reflector array 20 is set to about 2 times the distance between the imaging element 10 and the floating image.

In the imaging element 10, the tangent plane that contacts the first surface 11a at the lowest position in the negative Z2-axis side direction is the virtual plane P0 that is parallel to the XY-plane.

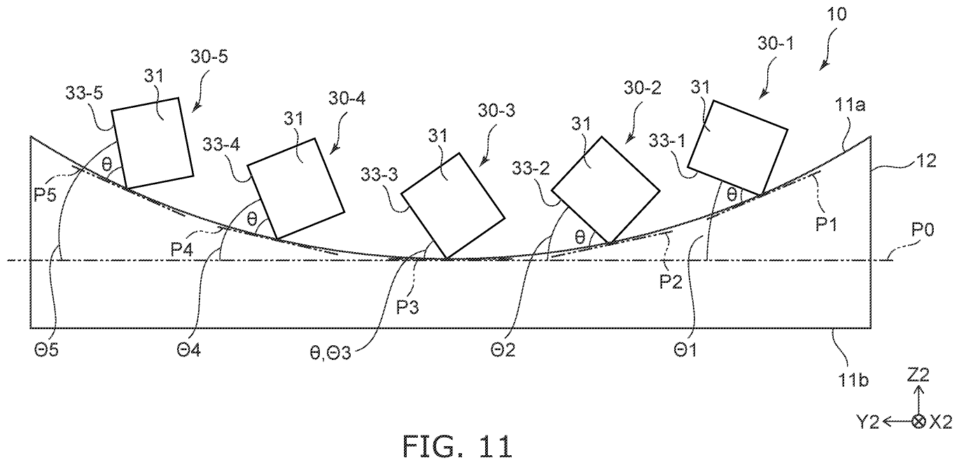

FIG. 11 is a schematic side view illustrating the imaging element of FIG. 6.

FIG. 11 shows one dihedral corner reflector included in the reflector rows 22 shown in FIGS. 6 and 8. As described with reference to FIGS. 6 and 8, the multiple reflector rows 22 each extend along the X2-direction and are arranged at substantially uniform spacing in the Y2-direction. The angles of the multiple dihedral corner reflectors included in one reflector row 22 with respect to the virtual plane P0 are substantially the same. Accordingly, the angle of the dihedral corner reflector 30 with respect to the virtual plane P0 refers to the angle with respect to the virtual plane P0 of the reflector row 22 to which the dihedral corner reflector 30 belongs.

FIG. 11 is an enlarged schematic illustration of five dihedral corner reflectors 30-1 to 30-5 among the many dihedral corner reflectors arranged in the Y2-direction. Although different reference numerals are used to differentiate the positions in the Y2-axis, the configurations of the dihedral corner reflectors 30-1 to 30-5 are the same as that of the dihedral corner reflector 30 described with reference to FIGS. 9A and 9B. The base part 36 shown in FIG. 9B is not illustrated to avoid complexity in the illustration.

As shown in FIG. 11, the dihedral corner reflectors 30-1 to 30-5 have different angles Θ1 to Θ5 with respect to the virtual plane P0 according to the positions in the Y2-axis along the first surface 11a. The angles Θ1 to Θ5 of the dihedral corner reflectors 30-1 to 30-5 are illustrated by the angles of the valley-side connecting lines (first straight lines) 33-1 to 33-5 with respect to the virtual plane P0.

In the example shown in FIG. 11, the dihedral corner reflectors 30-1 to 30-5 are arranged in this order in the positive direction of the Y2-axis. The angles Θ1 to Θ5 of the dihedral corner reflectors 30-1 to 30-5 are set to increase in this order. That is, the sizes of the angles Θ1 to Θ5 are set to Θ1<Θ2<Θ3<Θ4<Θ5.

More generally, when referenced to the reflector row (a first reflector row) 22 of the dihedral corner reflector set to the smallest value, the angles Θ1 to Θ5 of the dihedral corner reflectors 30-1 to 30-5 increase away from the reflector row 22 in one direction along the Y2-axis. Also, the angles Θ1 to Θ5 decrease away from the reference reflector row 22 in the other direction along the Y2-axis. In the example of FIG. 11, when the position of the dihedral corner reflector 30-1 set to the smallest angle is used as the reference, the sizes of the angles Θ1 to Θ5 are Θ1<Θ2<Θ3<Θ4<Θ5 in the positive direction of the Y2-axis.

The angles Θ1 to Θ5 of the dihedral corner reflector can be set so that 0°<Θ1 to Θ5<90°. Although the angles between the first reflecting surface 31 and the virtual plane P0 are determined according to the angles Θ1 to Θ5, 45°<(the angle between the first reflecting surface 31 and the virtual plane P0)<90° can be set. The angle between the second reflecting surface 32 and the virtual plane P0 is equal to the angle between the first reflecting surface 31 and the virtual plane P0. Accordingly, 45°<(the angle between the second reflecting surface 32 and the virtual plane P0)<90° can be set.

The tilts of the dihedral corner reflectors 30-1 to 30-5 also may be set using the angles with respect to tangent planes P1 to P5 of the first surface 11a at which the dihedral corner reflectors 30-1 to 30-5 are located. The angles of the dihedral corner reflectors 30-1 to 30-5 with respect to the tangent planes P1 to P5 are set to a constant angle θ regardless of the positions of the dihedral corner reflectors 30-1 to 30-5 in the Y2-axis. For example, the angle θ is based on the angle between the horizontal plane and each reflecting surface of a corner cube reflector and is set to about 30°, and more specifically, 35.3°.

In the imaging element 10 of the example, when referenced to the base member 12, the angles Θ1 to Θ5 of the dihedral corner reflectors 30-1 to 30-5 are appropriately set so that the light rays incident from the light source provided at the first surface 11a side are imaged at the first surface 11a side. The imaging position is at a different mid-air position from the light source. The angles of the dihedral corner reflectors with respect to the virtual plane P0 are determined by, for example, experiments, simulations, etc.

The angles of the dihedral corner reflectors with respect to the virtual plane P0 are set to increase according to the position in the Y2-axis, or are set to decrease according to the position in the Y2-axis; therefore, the first surface 11a may not be a portion of a circular arc of a perfect circle. For example, the first surface 11a may be a portion of an arc of an ellipse, or may be a portion of a polygon corresponding to the number of reflector rows. It is sufficient to be able to set the angles of the dihedral corner reflectors according to the positions of the dihedral corner reflectors in the Y2-axis; therefore, the angles of the dihedral corner reflectors may be referenced to another plane having any angle with respect to the virtual plane P0 without using the virtual plane P0 as a reference.

Modifications of the imaging element will now be described.

FIG. 12A is a schematic side view illustrating a portion, i.e., a modification of the imaging element, of the image display device according to the first embodiment.

FIG. 12B is a schematic side view illustrating a portion, i.e., another modification of the imaging element, of the image display device according to the first embodiment.

As long as the angles of the dihedral corner reflectors with respect to the virtual plane P0 can be set similarly to the imaging element 10 shown in FIG. 6, the reflector array 20 need not be formed on a curved surface, and may be provided on one plane.

Similarly to the description with reference to FIG. 11, FIGS. 12A and 12B are enlarged schematic illustrations of the five dihedral corner reflectors 30-1 to 30-5. The five dihedral corner reflectors 30-1 to 30-5 and their tilts corresponding to their positions are shown.

As shown in FIG. 12A, an imaging element 310 of the modification includes the reflector array 20 and a base member 312. The base member 312 includes the first surface 311a and a second surface 311b. The second surface 311b is positioned at the side opposite to the first surface 311a. The first surface 311a is a plane substantially parallel to the X2Y2-plane. The first surface 311a may be the virtual plane P0. Similarly to the example shown in FIG. 11, for example, the base member 312 is formed of a light-transmitting material.

The angles of the dihedral corner reflectors 30-1 to 30-5 with respect to the virtual plane P0 are respectively Θ1 to Θ5, and the sizes of the angles Θ1 to Θ5 are Θ1<Θ2<Θ3<Θ4<Θ5. The positions of the dihedral corner reflectors 30-1 to 30-5 in the Y2-axis are the same as the positions of the dihedral corner reflectors 30-1 to 30-5 in the Y2-axis shown in FIG. 11. Accordingly, for the tangent planes P1 to P5 of the circular arc corresponding to the positions in the Y2-axis of FIG. 11, the angles between the dihedral corner reflectors 30-1 to 30-5 and the tangent planes P1 to P5 all have the same value of the angle θ.

As shown in FIG. 12B, the imaging element 310a of the modification includes the reflector array 20 and the base member 312, and further includes a protective layer 314. The configurations of the reflector array 20 and the base member 312 are the same as those of the imaging element 310 described with reference to FIG. 12A. The protective layer 314 is provided to cover the reflector array 20 and the first surface 311a.

When the light rays are incident on the imaging element 310a via the protective layer 314, the protective layer 314 includes a material having high light transmissivity so that the transmitted amount of the light rays is substantially constant. It is favorable for a surface 313a of the protective layer 314 to be sufficiently flat so that the refraction angles of the incident light rays are substantially constant.

According to the modification, the base member 312 can be a flat plate, and so the thickness of the base member necessary to make the first surface and/or the second surface into a curved surface can be reduced; therefore, the imaging elements 310 and 310a can be thinned. The imaging element 310 shown in FIG. 12A is a member in which the reflector array 20 is formed at the first surface 311a of the base member 312, and the second surface 311b has a flat surface. Therefore, production by a press using a resin base member is favorable. Also, the production of the imaging element 310 is advantageous in that production by a roll-to-roll method is easy. The roll-to-roll method is a production technique in which a base member that is wound in a roll shape is continuously supplied to the process for patterning, processing, etc. The roll-to-roll method is widely utilized in the production of plate-shaped or film-like plastic molded products, etc.

The image display device 1000 according to the embodiment includes the imaging element 310a shown in FIG. 12B. The configuration is not limited thereto; the image display device may include any of the imaging elements 10 and 310 described above. The components of the imaging elements 10, 310, and 310a can be combined as appropriate. For example, the protective layer 314 may be provided at the first surface 11a side of the imaging element 10.

The operation of the imaging element, including the operation principle, will now be described. Unless otherwise noted hereinbelow, the imaging element 10 described with reference to FIGS. 6 to 11 will be described. The operations of the imaging elements 310 and 310a of the modifications can be understood similarly to the imaging element 10.

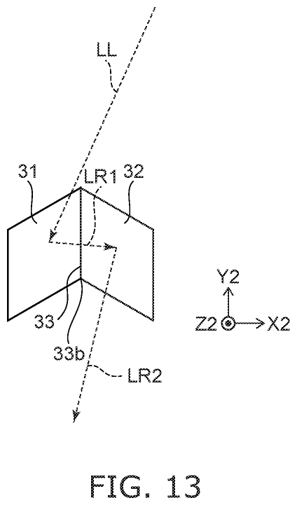

FIG. 13 is a schematic plan view for describing a portion, i.e., an operation of the imaging element, of the image display device according to the first embodiment.

As shown in FIG. 13, the first reflecting surface 31 and the second reflecting surface 32 are provided to be substantially orthogonal and connected at the valley-side connecting line 33. The vertex 33b is provided to have a minimum value in the Z2-axis direction.

The light ray LL that is incident on the first reflecting surface 31 is reflected by the first reflecting surface 31. The once-reflected light LR1 that is reflected by the first reflecting surface 31 is reflected by the second reflecting surface 32. Unlike a corner cube reflector (e.g., Patent Literature 2), the dihedral corner reflector 30 does not include a third reflecting surface; therefore, the twice-reflected light LR2 that is reflected by the second reflecting surface 32 travels straight as-is. Here, the valley-side connecting line 33 is provided at a prescribed angle with respect to the X2Y2-plane; therefore, the twice-reflected light LR2 that is emitted from the dihedral corner reflector 30 is emitted toward the same side as the side at which the light ray LL is incident.

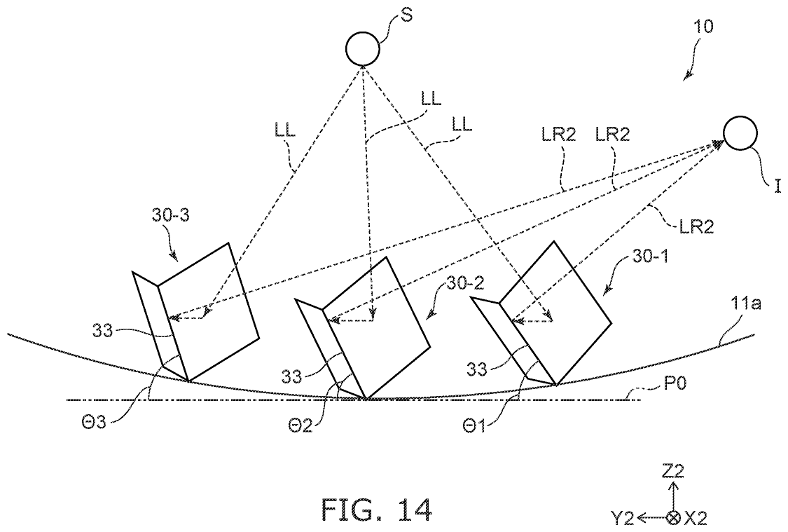

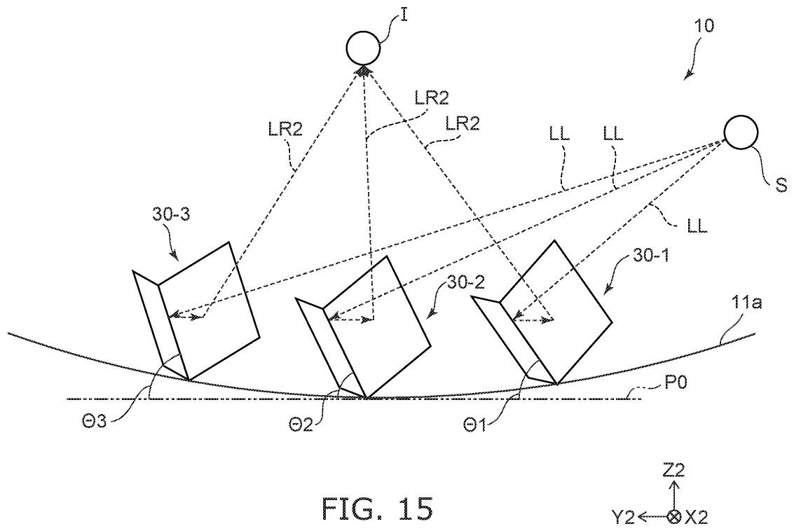

FIGS. 14 and 15 are schematic side views for describing a portion, i.e., an operation of the imaging element, of the image display device according to the first embodiment.

In the example of FIG. 14, a light source S is located in the normal direction of the virtual plane P0 at the first surface 11a side. In the imaging elements 310 and 310a of the modifications shown in FIGS. 12A and 12B, the light source is located in the normal direction of the first surface 311a at the first surface 311a side.

In the imaging element 10 as shown in FIG. 14, the first surface 11a is set to be a portion of a circular arc that is convex toward the negative Z2-axis side when projected onto the YZ-plane. The dihedral corner reflectors 30-1 to 30-3 are located on the first surface 11a. In the example shown in FIG. 14, the angles Θ1 to Θ3 that indicate the tilts of the dihedral corner reflectors 30-1 to 30-3 with respect to the virtual plane P0 are set to increase in the positive direction of the Y2-axis. Thus, by setting the angles Θ1 to Θ3, the twice-reflected light LR2 that is reflected twice by the dihedral corner reflector 30 forms a floating image I at the first surface 11a side at which the light source S is provided.

The imaging element 10 operates even when the position of the light source S and the position of the floating image I are interchanged.

In FIG. 15, the configurations of the dihedral corner reflectors 30-1 to 30-3 and the relationship of the dihedral corner reflectors 30-1 to 30-3, the first surface 11a, and the virtual plane P0 are the same as those described with reference to FIG. 14.

As shown in FIG. 15, the light source S is located at the position of the floating image I described with reference to FIG. 14; in such a case, the floating image I is formed at the position of the light source S in FIG. 14. The light rays LL that are emitted from the light source S each are reflected twice by the dihedral corner reflectors 30-1 to 30-3, and the twice-reflected light LR2 forms a floating image at the position of the floating image I. That is, in the example shown in FIG. 15, the floating image I is formed in the normal direction of the virtual plane P0 at the first surface 11a side. In the case of the imaging elements 310 and 310a according to the modification shown in FIGS. 12A and 12B, the floating image is formed in the normal direction of the first surface 311a at the first surface 311a side.

When the light source S is at either position, the angles of the dihedral corner reflectors can be appropriately set by using experiments, simulations, etc., to form the floating image at the desired position by reflecting the light ray incident on the dihedral corner reflector twice. For example, according to the embodiment shown in FIG. 14, the light source S is set to be substantially directly above the reflector array; according to the embodiment shown in FIG. 15, the position at which the floating image I is formed is set to be substantially directly above the reflector array. It is also possible to appropriately modify the positions of the light source S and the floating image I by appropriately adjusting the angles of the dihedral corner reflectors with respect to the virtual plane P0. When making such a design modification, ray analysis tools such as ray tracing simulation, etc., can be effectively utilized.

In the image display device 1000 according to the embodiment, the floating image is formed directly above the reflector array. In such a case as well, it is possible to interchange the position of the display device 1100(S), which is the light source, and the position at which the floating image I is formed. For the image display device 1000 of FIG. 1, it goes without saying that if the position of the display device 1100(S) and the position at which the floating image is formed are interchanged, it is necessary to modify the configurations of the housing and the light-transmitting member according to the optical path after interchanging.

Effects of the image display device 1000 according to the embodiment will now be described.

The image display device 1000 according to the embodiment includes the imaging element 310a. In the imaging element 310a as shown in FIG. 8, FIG. 12B, etc., the angles of the dihedral corner reflectors 30 with respect to the virtual plane P0 are set to be greater than 0° and less than 90°. Also, the angles of the dihedral corner reflectors 30 with respect to the virtual plane P0 are set to be different according to the position at which the dihedral corner reflector 30 is located in the Y2-axial direction, are set to increase away from the dihedral corner reflector 30 of the reference position in one direction of the Y2-axial direction, and are set to decrease away from the dihedral corner reflector 30 in the other direction of the Y2-axial direction. By such a setting, the light ray from the first surface 311a side with respect to the base member 312 can be reflected twice, and a floating image can be formed at the first surface 311a side.

In the imaging element 310a, by appropriately setting the angles of the dihedral corner reflectors 30 with respect to the virtual plane P0, the display devices 1100(S)a and 1100(S)b can be located at any position at the first surface 311a side with respect to the base member 312, and the floating images I1a and I1b can be formed at the desired positions directly above the reflector array.

The image display device 1000 according to the embodiment includes the multiple display devices 1100(S)a and 1100(S)b. By appropriately setting the positions of the multiple display devices 1100(S)a and 1100(S)b and the angles at which the light is emitted, the floating images I1a and I1b that correspond to the images formed by the light emitted by the multiple display devices 1100(S)a and 1100(S)b can be formed in mid-air without overlapping each other.

By arranging the display devices 1100(S)a and 1100(S)b along the α-direction (the third direction), the imaging element 310a that is arranged to be separated from the display devices 1100(S)a and 1100(S)b in the α-direction can form the floating images I1a and I1b at the different positions along the α-direction.

### Second Embodiment

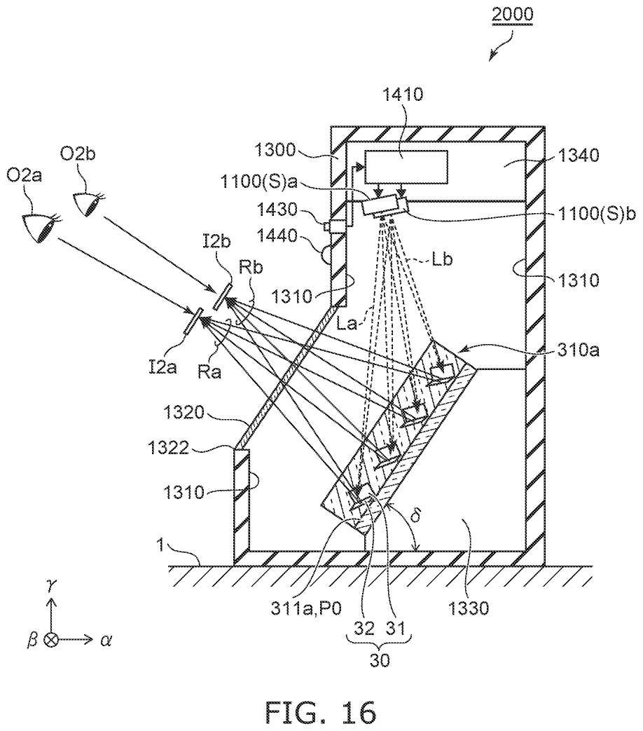

FIG. 16 is a schematic cross-sectional view illustrating an image display device according to a second embodiment.

As shown in FIG. 16, the image display device 2000 according to the embodiment includes the imaging element 310a and the multiple display devices 1100(S)a and 1100(S)b. Similarly to the image display device 1000 shown in FIG. 1, the image display device 2000 includes the control device 1410 and the imaging part 1430, and may include the camera lighting 1440. The arrangement of the display devices 1100(S)a and 1100(S)b of the image display device 2000 according to the embodiment is different from that of the image display device 1000 shown in FIG. 1. Otherwise, the components of the image display device 2000 according to the embodiment are the same as the components of the image display device 1000 according to the first embodiment; the same components are marked with the same reference numerals, and a detailed description is omitted as appropriate.

The display devices 1100(S)a and 1100(S)b are located in a plane parallel to the αβ-plane and are arranged along the β-direction. Similarly to the example shown in FIG. 1, the imaging element 310a is located in a plane that is parallel to the β-direction at the angle δ of not less than 0° from the αβ-plane. That is, the β-direction (a fourth direction) is parallel to the X2Y2-plane.

The display device 1100(S)a is arranged to emit the light La toward the imaging element 310a. The display device 1100(S)b is arranged to emit the light Lb toward the imaging element 310a.

In the imaging element 310a, similarly to the example shown in FIG. 2, the reflector row 22 extends in a direction orthogonal to the α-direction, i.e., the β-direction, when viewed from the γ-direction; the multiple reflector rows 22 are arranged along the α-direction.

The imaging element 310a is arranged so that the light La is incident on the imaging element 310a; the imaging element 310a emits the reflected light Ra, the light Lb is incident on the imaging element 310a, and the imaging element 310a emits the reflected light Rb. Similarly to the example shown in FIG. 2, the angles at which the reflected light Ra and Rb is emitted are substantially the normal direction of the first surface 311a and the virtual plane P0. That is, the reflected light Ra and Rb is emitted at angles of substantially 90°−δ from the αβ-plane. The reflected light Ra and Rb that is emitted respectively form the floating images I1a and I1b.

FIG. 17 is a schematic view for describing the positions of the display devices, the imaging element, and the floating images of the image display device according to the second embodiment.

The arrangement of the display devices 1100(S)a and 1100(S)b of the image display device 2000 according to the embodiment will now be described using FIG. 17.

In the image display device 2000, floating images I2a and I2b are formed at different positions due to the arrangement of the display devices 1100(S)a and 1100(S)b, and different observers O2a and O2b observe the floating images I2a and I2b. FIG. 17 also shows the positions of the observers O2a and O2b observing the floating images I2a and I2b displayed by the image display device 2000. FIG. 17 is a schematic view when the image display device 2000, the floating images I2a and I2b, and the observers O2a and O2b are viewed from the positive side toward the negative side of the γ-axis.

The positive direction of the α-axis is taken as the direction from the observers O2a and O2b toward the image display device 2000, and the observers O2a and O2b are taken to be arranged at positions separated in the β-direction. In such a case, as shown in FIG. 17, the imaging element 310a and the display device 1100(S)a are arranged in the α-direction, and the imaging element 310a and the display device 1100(S)b also are arranged in the α-direction.

In the imaging element 310a similarly to the example shown in FIG. 1, the reflector row 22 extends orthogonal to the α-direction, and the multiple reflector rows 22 are arranged in the α-direction.

The two display devices 1100(S)a and 1100(S)b are arranged along the β-direction. In the specific example of FIG. 17, the display devices 1100(S)a and 1100(S)b are arranged in this order in the positive direction of the β-direction. The display devices 1100(S)a and 1100(S)b are arranged to emit the light La and Lb toward the imaging element 310a.

The light La that is emitted from the display device 1100(S)a is reflected by the imaging element 310a, and the imaging element 310a emits the reflected light Ra. The reflected light Ra forms the floating image I2a. The light Lb that is emitted from the display device 1100(S)b is reflected by the imaging element 310a, and the imaging element 310a emits the reflected light Rb. The reflected light Rb forms the floating image I2b. The floating image I2a is formed between the image display device 2000 and the observer O2a, and the floating image I2b is formed between the image display device 2000 and the observer O2b. The floating images I2a and I2b are formed to be separated in the β-direction.

The floating images I2a and I2b can be formed to be arranged along the β-direction as in the example of FIG. 17 by appropriately setting the positions and angles of the display devices 1100(S)a and 1100(S)b and by appropriately setting the position of the imaging element 310a and the angle of the first surface 311a from the αβ-plane. By providing a sufficient distance between the position at which the floating image I2a is formed and the position at which the floating image I2b is formed, the observer O2a can observe the floating image I2a, and the observer O2b can observe the floating image I2b.

For example, the image display device 2000 is located in a vehicle such as an automobile, etc., and when the observer O2a is the driver and the observer O2b is a passenger, the image display device 2000 can display the floating image I2a as information for the driver and the floating image I2b as the information for the passenger. Three or more floating images can be formed at different formation positions by using three or more display devices.

Effects of the image display device 2000 according to the embodiment will now be described.

The image display device 2000 according to the embodiment provides effects similar to the image display device 1000 according to the first embodiment. The image display device 2000 also provides the following effects. Namely, the floating images I2a and I2b can be formed to be separated in the β-direction by arranging the multiple display devices 1100(S)a and 1100(S)b to be separated along the β-direction (the fourth direction). The multiple floating images I2a and I2b can be formed at sufficiently separated positions by appropriately setting the separation distance, light emergence angles, etc., of the display devices 1100(S)a and 1100(S)b. The floating images I2a and I2b that are formed at sufficiently separated positions can be observed respectively by the multiple observers O2a and O2b, and even a single image display device 2000 can provide information to the multiple users. Although multiple users are assumed in the specific example above, the multiple display devices 1100(S)a and 1100(S)b can be arranged to be separated along the β-direction so that a single user can simultaneously observe the floating images I2a and I2b.

### Third Embodiment

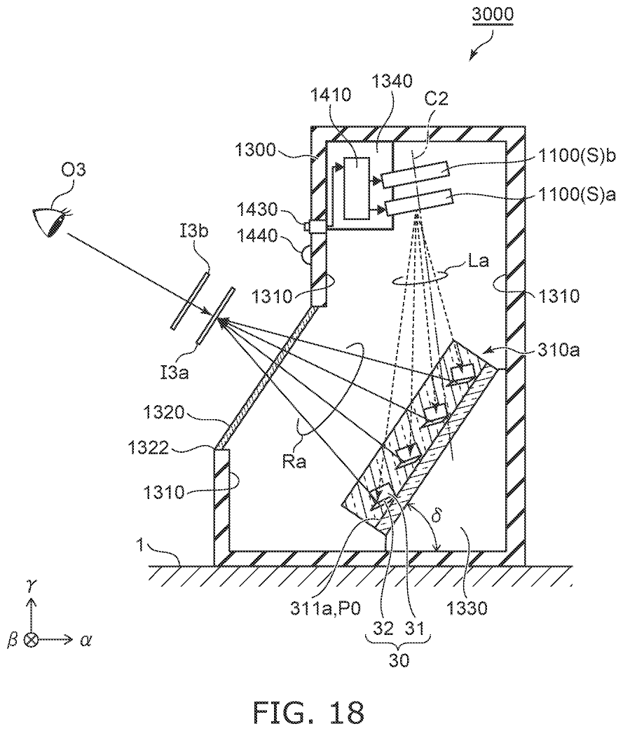

FIG. 18 is a schematic cross-sectional view illustrating an image display device according to a third embodiment.

As shown in FIG. 18, the image display device 3000 according to the embodiment includes the imaging element 310a and the multiple display devices 1100(S)a and 1100(S)b. Similarly to the image display device 1000 shown in FIG. 1, the image display device 3000 includes the control device 1410 and the imaging part 1430, and may include the camera lighting 1440. The arrangement of the display devices 1100(S)a and 1100(S)b of the image display device 3000 according to the embodiment is different from that of the image display device 1000 shown in FIG. 1. Otherwise, the components of the image display device 3000 according to the embodiment are the same as the components of the image display device 1000 according to the first embodiment; the same components are marked with the same reference numerals, and a detailed description is omitted as appropriate.

The display devices 1100(S)a and 1100(S)b are arranged so that the emitted light is oriented toward the imaging element 310a. The display device (a second light source) 1100(S)b is located on a straight line (a second straight line) C2 connecting the display device (a first light source) 1100(S)a and the imaging element 310a. For example, the straight line C2 crosses the first surface 1111a of the substrate 1110 of each of the display devices 1100(S)a and 1100(S)b shown in FIGS. 2A to 3B and crosses the first surface 311a of the imaging element 310a.

The display device 1100(S)a that is located more proximate to the imaging element 310a must be configured to transmit the light emitted by the display device 1100(S)b. As described with reference to FIGS. 3A to 4B, the display device 1100(S)a can be made to transmit light by forming the substrates 1110 of the display devices 1100(S)a and 1100(S)b from a light-transmitting material such as glass, etc.

The display device 1100(S)a emits the light La, the light La is incident on the imaging element 310a, and the imaging element 310a emits the reflected light Ra. The reflected light Ra that is emitted forms a floating image I3a. The display device 1100(S)b emits the light Lb, the light Lb is incident on the imaging element 310a, and the imaging element 310a emits the reflected light Rb. The reflected light Rb that is emitted forms a floating image I3b.

Because the display device 1100(S)a is located more proximate to the imaging element 310a than the display device 1100(S)b, the floating image I3a formed by the reflected light Ra of the imaging element 310a is formed more proximate to the imaging element 310a. The floating image I3b that is formed by the light emitted by the display device 1100(S)b is formed to be more distant to the imaging element 310a than the floating image I3a. When viewed by an observer O3, the position of the floating image I3a of the display device 1100(S)a appears more distant than the position of the floating image I3b of the display device 1100(S)b. The floating images I3a and I3b can be formed at overlapping positions when viewed by the observer O3 by appropriately setting the positions and light emergence angles of the display devices 1100(S)a and 1100(S)b, the mounting angle of the imaging element 310a, etc. Thus, the observer O3 can obtain more information and can view a three-dimensional image.

Effects of the image display device 3000 according to the embodiment will now be described.

The image display device 3000 according to the embodiment provides effects similar to the image display device 1000 according to the first embodiment. The image display device 3000 also provides the following effects. Namely, the image display device 3000 includes the multiple display devices 1100(S)a and 1100(S)b, and the display device 1100(S)b is located on a straight line connecting the display device 1100(S)a and the imaging element 310a. Therefore, when viewed by the observer O3, the floating images I3a and I3b that appear to overlap at least partially can be formed in mid-air. By using different images for the floating images I3a and I3b, the observer O3 can observe a mid-air image having more information. The observer O3 can observe a three-dimensional image.

### Fourth Embodiment

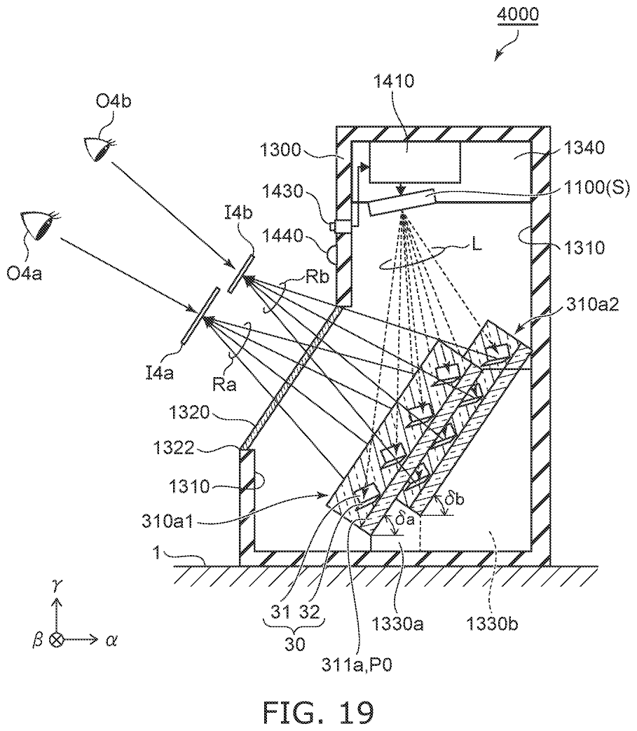

FIG. 19 is a schematic cross-sectional view illustrating an image display device according to a fourth embodiment.

As shown in FIG. 19, the image display device 4000 according to the embodiment includes multiple imaging elements 310a1 and 310a2 and the display device 1100(S). Similarly to the image display device 1000 shown in FIG. 1, the image display device 2000 includes the control device 1410 and the imaging part 1430 and may include the camera lighting 1440 as well. The image display device 4000 according to the embodiment differs from the image display device 1000 according to the first embodiment in that the multiple imaging elements 310a1 and 310a2 are included instead of multiple display devices. Otherwise, the components of the image display device 4000 according to the embodiment are the same as the components of the image display device 1000 according to the first embodiment; the same components are marked with the same reference numerals, and a detailed description is omitted as appropriate.

The display device 1100(S) is arranged to emit a light L toward the multiple imaging elements 310a1 and 310a2.

The multiple imaging elements 310a1 and 310a2 are differentiated by using different reference numerals. The imaging elements 310a1 and 310a2 include the same configuration as the imaging element 310a described with reference to FIG. 12B.

The multiple imaging elements 310a1 and 310a2 are arranged to be separated in the β-direction. The imaging element 310a1 is located in a plane that is parallel to the β-direction at an angle δa not less than 0° from the αβ-plane. The imaging element 310a2 is located in a plane that is parallel to the β-direction at an angle δb not less than 0° from the αβ-plane. That is, the β-direction (a sixth direction) is parallel to the X2Y2-plane. The angles δa and δb may be the same or different. The angles δa and δb are appropriate values selected according to the positions at which floating images I4a and I4b are formed.

In the imaging elements 310a1 and 310a2, similarly to the example shown in FIG. 2, when viewed from the γ-direction, the reflector rows 22 each extend in a direction orthogonal to the α-direction, i.e., the β-direction; the multiple reflector rows 22 are arranged along the α-direction. The reflector rows 22 of the imaging elements 310a1 and 310a2 may extend in parallel directions, or may have angles greater than 0° from the β-axis according to the positions of the floating images I4a and I4b.

The imaging element 310a1 is arranged so that the light L is incident on the imaging element 310al, and the imaging element 310a1 emits the reflected light Ra. The imaging element 310a2 is arranged so that the light L is incident on the imaging element 310a2, and the imaging element 310a2 emits the reflected light Rb. Similarly to the example shown in FIG. 2, the angles at which the reflected light Ra and Rb is emitted are normal directions of the first surface 311a and the virtual plane P0. That is, the reflected light Ra is emitted at an angle of substantially 90°−δa from the αβ-plane, and the reflected light Rb is emitted at an angle of substantially 90°−δb from the αβ-plane. The reflected light Ra and Rb that is emitted respectively form the floating images I4a and I4b.

FIG. 20 is a schematic view for describing the positions of the display device, the imaging elements, and the floating images of the image display device according to the fourth embodiment.

The arrangement of the imaging elements 310a1 and 310a2 of the image display device 4000 according to the embodiment will now be described using FIG. 20.

In the image display device 4000, similarly to the image display device 2000 described with reference to FIG. 17, the floating images I4a and I4b are formed at different positions due to the arrangement of the imaging elements 310a1 and 310a2; and different observers O4a and O4b can observe the floating images I4a and I4b. FIG. 20 also shows the positions of the observers O4a and O4b observing the floating images I4a and I4b displayed by the image display device 4000. FIG. 20 is a schematic view when the image display device 4000, the floating images I4a and I4b, and the observers O4a and O4b are viewed from the positive side toward the negative side of the γ-axis.

The positive direction of the α-axis is taken as the direction from the observers O2a and O2b toward the image display device 4000, and the observers O4a and O4b are taken to be arranged at positions separated in the β-direction. In such a case, as shown in FIG. 20, the imaging element 310a1 and the display device 1100(S) are arranged in the α-direction, and the imaging element 310a2 and the display device 1100(S) also are arranged in the α-direction. The imaging element 310a1 and the imaging element 310a2 are arranged to be separated in the β-direction.

Similarly to the example shown in FIG. 1, the imaging elements 310a1 and 310a2 are arranged so that the reflector row 22 extends orthogonal to the α-direction; the multiple reflector rows 22 are arranged in the α-direction.

The light L that is emitted from the display device 1100(S) is reflected by the imaging element 310al, and the imaging element 310a1 emits the reflected light Ra. The reflected light Ra forms the floating image I4a. Simultaneously, the light L that is emitted from the display device 1100(S) is reflected by the imaging element 310a2, and the imaging element 310a2 emits the reflected light Rb. The reflected light Rb forms the floating image I4b. The floating image I4a is formed between the image display device 4000 and the observer O4a, and the floating image I4b is formed between the image display device 4000 and the observer O4b. The floating images I4a and I4b are formed to be separated in the β-direction.

The floating images I4a and I4b can be formed to be arranged along the β-direction by appropriately setting the position and the angle of the light emission surface from the αβ-plane of the display device 1100(S) and by appropriately setting the positions of the imaging elements 310a1 and 310a2 and the angles δa and δb of the first surface 311a from the αβ-plane. By providing a sufficient distance between the position at which the floating image I4a is formed and the position at which the floating image I4b is formed, the observer O4a can observe the floating image I4a, and the observer O4b can observe the floating image I4b. In the image display device 4000 according to the embodiment, the floating images I4a and I4b formed by the reflected light Ra and Rb are the same image because the display device 1100(S) simultaneously emits the light L forming the same image toward the multiple imaging elements 310a1 and 310a2.

Effects of the image display device 4000 according to the embodiment will now be described.

The image display device 4000 according to the embodiment provides effects similar to the image display device 1000 according to the first embodiment. The image display device 4000 also provides the following effects. Namely, the floating images I4a and I4b can be formed to be separated in the β-direction by arranging the multiple imaging elements 310a1 and 310a2 to be separated along the β-direction. The multiple floating images I4a and I4b can be formed to be sufficiently separated by appropriately setting the separation distance, light emergence angles, etc., of the imaging elements 310a1 and 310a2. The floating images I4a and I4b display the same image, and even a single image display device 4000 can provide the same information simultaneously to multiple users.

Instead of arranging the multiple imaging elements 310a1 and 310a2 to be separated in the β-direction (the sixth direction), the multiple imaging elements 310a1 and 310a2 may be arranged to be separated in the α-direction (a fifth direction). In such a case, the floating images I4a and I4b can be formed to be separated in the α-direction. Three or more floating images may be formed by providing three or more imaging elements.

### Fifth Embodiment

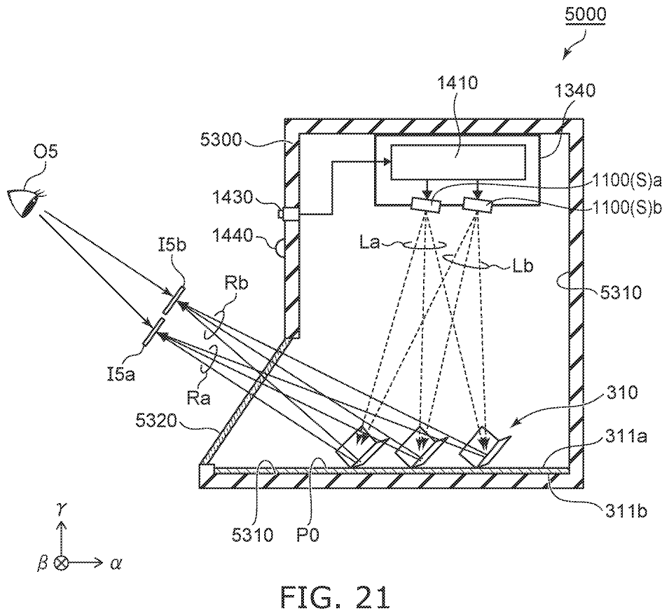

FIG. 21 is a schematic cross-sectional view illustrating an image display device according to a fifth embodiment.

As shown in FIG. 21, the image display device 5000 according to the embodiment includes the imaging element 310 and the multiple display devices 1100(S)a and 1100(S)b. Similarly to the image display devices 1000 to 4000, the image display device 5000 according to the embodiment may include the imaging part 1430 and may include the camera lighting 1440 as well. The relationship between the positions of the display devices 1100(S)a and 1100(S)b and the position of the imaging element 310 of the image display device 5000 is different from those of the image display devices 1000 to 4000. The image display device 5000 includes the imaging element 310 that is different from the imaging element 310a of the image display devices 1000 to 4000. Otherwise, the components of the image display device 5000 are the same as the components of the image display devices 1000 to 4000; the same components are marked with the same reference numerals, and a detailed description is omitted as appropriate.

In the image display device 5000, similarly to the image display device 1000 shown in FIG. 1, the multiple display devices 1100(S)a and 1100(S)b are arranged in a plane parallel to the αβ-plane and are arranged along the α-direction. The imaging element 310 is located at the bottom portion inside a housing 5300. The virtual plane P0 and the first surface 311a of the imaging element 310 are arranged to be parallel to the αβ-plane. The display devices 1100(S)a and 1100(S)b are located directly above the imaging element 310 and irradiate the light La and Lb toward the imaging element 310. The imaging element 310 reflects the light La and Lb and emits the reflected light Ra and Rb obliquely above the first surface 311a. The reflected light Ra and Rb that are reflected by the imaging element 310 respectively form floating images I5a and I5b. The floating images I5a and I5b are formed to be arranged in the α-direction.

Any of the configurations of the imaging elements 10, 310, and 310a is provided as the imaging element 310 according to the space inside the housing, the mounting location of the image display device, etc., as described with reference to FIGS. 12A and 12B. Although the image display device 5000 according to the embodiment includes the imaging element 310, the other imaging elements 10 and 310a may be included according to the housing, etc.

In the image display device 5000, the display devices 1100(S)a and 1100(S)b are located directly above the imaging element 310. The shape of the housing 5300 is set for such an arrangement. Any appropriate shape or the like of the housing may be used.

The light La and Lb that is emitted by the display devices 1100(S)a and 1100(S)b travels downward and is irradiated on the imaging element 310 because the display devices 1100(S)a and 1100(S)b are located directly above the imaging element 310. The imaging element 310 reflects a portion of the incident light twice with the dihedral corner reflector and emits the reflected light Ra and Rb. A window member 5320 is arranged to transmit the reflected light Ra and Rb reflected twice by the imaging element 310.

The light that is reflected only once by the dihedral corner reflector of the imaging element 310 and the light that is not reflected by the dihedral corner reflector escape to the second surface 311b side through the spacing 23 between the adjacent reflector rows 22 shown in FIG. 5. Accordingly, the imaging element 310 does not emit light other than the twice-reflected light to the first surface 311a side. Therefore, in the image display device 5000 according to the embodiment, the display device 1100(S), which is the light source, is arranged in the normal direction of the first surface 311a of the imaging element 310; therefore, the spacing 23 between the adjacent reflector rows 22 is provided in the imaging element 310.

In the example, a light-shielding member 5310 is located at the bottom surface inside the housing 5300 so that the light escaping toward the second surface 311b is not re-reflected inside the housing 5300 to become stray light. The light-shielding member 5310 also is located at the sidewall surface inside the housing 5300. Similarly to the light-shielding member 1310 shown in FIG. 1, the light-shielding member 5310 is, for example, a coated film of a black coating material formed on the bottom surface and wall surface of the interior wall of the housing 5300. The light-shielding member 5310 is illustrated as an interior surface of the housing 5300 in FIG. 21 because the light-shielding member 5310 is sufficiently thin compared to the thickness of the constituent material of the housing 5300.

In the image display device 5000 according to the embodiment, the imaging element 310 emits only the twice-reflected light Ra and Rb of the incident light La and Lb, and does not reflect the other light toward the first surface 311a side. Therefore, as described with reference to FIG. 14, the imaging element 310 reduces the formation of ghost images other than the real images at the first surface 311a side.

Effects of the image display device 5000 according to the embodiment will now be described.

The image display device 5000 according to the embodiment provides effects similar to the image display device 1000 according to the first embodiment described above. In the image display device 5000 according to the embodiment, the display device 1100(S) is located substantially directly above the imaging element 310 in the normal direction of the first surface 311a, and the twice-reflected light of the imaging element 310 is emitted and forms floating images at the side of the imaging element 310. Therefore, the display of ghost images other than the real images can be prevented.

In the image display device 5000 according to the embodiment, the display devices, which are the light sources, may be arranged to form mid-air images substantially directly above the imaging element as in the image display devices 1000 to 4000 according to the other embodiments.

The relationship between the display devices, the imaging element, and the formation positions of the floating images according to the embodiment is applicable to the image display devices 1000 to 4000 according to the other embodiments described above. It goes without saying that the relationship between the display devices, the imaging element, and the formation positions of the floating images according to the embodiment provides the same effects as those described above when applied to the image display devices according to the other embodiments.

According to the embodiments described above, an image display device can be realized in which a simple structure can display an image in mid-air.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments herein may be made without departing from the spirit of the inventions. The accompanying claims and their equivalents are intended to cover such forms or modifications as would fall within the scope and spirit of the inventions. Also, the embodiments described above can be implemented in combination with each other.

What is claimed is:

1. An image display device comprising:
a plurality of light sources; and
an imaging element configured to reflect light from the plurality of light sources and to form a plurality of floating images in mid-air, the imaging element comprising:
a base member, and a reflector array provided on the base member, the base member including a first surface and a second surface, the second surface being positioned at a side opposite to the first surface, or
a base member comprising a reflector array, the base member including a first surface and a second surface, the second surface being positioned at a side opposite to the first surface, wherein:
the reflector array includes a plurality of reflector rows, each of the plurality of reflector rows comprising a plurality of dihedral corner reflectors arranged along a first direction,
each of the plurality of dihedral corner reflectors includes:
a first reflecting surface configured to reflect light from the first surface side, and
a second reflecting surface oriented to be orthogonal to the first reflecting surface and configured to reflect a reflected light from the first reflecting surface toward the first surface side,
in each reflector row of the plurality of reflector rows, an angle between a first straight line at which the first reflecting surface and the second reflecting surface meet and a plane in which the first direction and a second direction intersecting the first direction extend is set to a value greater than 0° and less than 90°,
an angle between the first reflecting surface and the plane is set to a value greater than 45° and less than 90°,
the plurality of reflector rows include a first reflector row in which the angle between the first straight line and the plane is set to a smallest value among those of the plurality of reflector rows,
reflector rows other than the first reflector row are configured such that the angle between the first straight line and the plane is set to values that increase away from the first reflector row along the second direction.

2. The device according to claim 1, wherein:
the plurality of light sources are arranged along a third direction and are configured to irradiate light toward the imaging element, the third direction crossing a plane that includes the first and second directions, and
the imaging element is configured to form the plurality of floating images at different positions.

3. The device according to claim 1, wherein:
the plurality of light sources are arranged along a fourth direction and are configured to irradiate light toward the imaging element, the fourth direction being parallel to a plane that includes the first and second directions, and
the imaging element is configured to form the plurality of floating images at different positions.

4. The device according to claim 1, wherein:
the plurality of light sources includes a first light source and a second light source, and
the second light source is located on a second straight line connecting the first light source and the imaging element.

5. An image display device comprising:
a light source; and
a plurality of imaging elements configured to reflect light from the light source and to form a floating image in mid-air, each of the imaging elements comprising:
a base member, and a reflector array provided on the base member, the base member including a first surface and a second surface, the second surface being positioned at a side opposite to the first surface, or
a base member comprising a reflector array, the base member including a first surface and a second surface, the second surface being positioned at a side opposite to the first surface, wherein:
the reflector array includes a plurality of reflector rows, each of the plurality of reflector rows comprising a plurality of dihedral corner reflectors arranged along a first direction,
each of the plurality of dihedral corner reflectors includes:
a first reflecting surface configured to reflect light from the first surface side, and
a second reflecting surface oriented to be orthogonal to the first reflecting surface, and configured to reflect a reflected light from the first reflecting surface toward the first surface side,
in each reflector row of the plurality of reflector rows, an angle between a first straight line at which the first reflecting surface and the second reflecting surface meet and a plane in which the first direction and a second direction intersecting the first direction extend is set to a value greater than 0° and less than 90°,
an angle between the first reflecting surface and the plane is set to a value greater than 45° and less than 90°,
the plurality of reflector rows include a first reflector row in which the angle between the first straight line and the plane is set to a smallest value among those of the plurality of reflector rows,
reflector rows other than the first reflector row are configured such that the angle between the first straight line and the plane is set to values that increase away from the first reflector row along the second direction.

6. The device according to claim 5, wherein:
the plurality of imaging elements are arranged along a fifth direction and are configured to reflect light from the light source, the fifth direction crossing a plane that includes the first and second directions, and
the plurality of imaging elements are configured to form the plurality of floating images at different positions along the fifth direction.

7. The device according to claim 5, wherein:
the plurality of imaging elements are arranged along a sixth direction and are configured to reflect light from the light source, the sixth direction being parallel to a plane that includes the first and second directions, and
the plurality of imaging elements are configured to form the plurality of floating images at different positions along the sixth direction.

8. An image display device comprising:
a plurality of light sources; and
an imaging element configured to reflect light from the plurality of light sources and to form a plurality of respective floating images in mid-air, the imaging element comprising:
a base member, and a reflector array provided on the base member, the base member including a first surface and a second surface, the second surface being positioned at a side opposite to the first surface, or
a base member comprising a reflector array, the base member including a first surface and a second surface, the second surface being positioned at a side opposite to the first surface, wherein:
the reflector array includes a plurality of reflector rows, each of the plurality of reflector rows including a plurality of dihedral corner reflectors arranged along a first direction,
the plurality of reflector rows are arranged in a second direction to be parallel to each other with a spacing therebetween, the second direction intersecting the first direction,
each of the plurality of dihedral corner reflectors includes:
a first reflecting surface configured to reflect light from the first surface side, and
a second reflecting surface oriented to be orthogonal to the first reflecting surface, and configured to reflect a reflected light reflected from the first reflecting surface toward the first surface side,
in each reflector row of the plurality of reflector rows, an angle between a first straight line at which the first reflecting surface and the second reflecting surface meet and a plane in which the first direction and the second direction intersect is set to a value greater than 0° and less than 90°,
an angle between the first reflecting surface and the plane is set to a value greater than 45° and less than 90°,
the plurality of reflector rows include a first reflector row in which the angle between the first straight line and the plane is set to a smallest value among those of the plurality of reflector rows,
reflector rows other than the first reflector row are configured such that the angle between the first straight line and the plane is set to values that increase away from the first reflector row in one direction along the second direction.

9. An image display device comprising:
a light source; and
a plurality of imaging elements configured to reflect light from the light source and forming a floating image in mid-air, each of the imaging elements comprising:
a base member, and a reflector array provided on the base member, the base member including a first surface and a second surface, the second surface being positioned at a side opposite to the first surface, or
a base member comprising a reflector array, the base member including a first surface and a second surface, the second surface being positioned at a side opposite to the first surface, wherein:
the reflector array includes a plurality of reflector rows, each of the plurality of reflector rows including a plurality of dihedral corner reflectors arranged along a first direction,
the plurality of reflector rows are arranged in a second direction to be parallel to each other with a spacing therebetween, the second direction intersecting the first direction,
each of the plurality of dihedral corner reflectors includes:
a first reflecting surface configured to reflect light from the first surface side, and
a second reflecting surface oriented to be orthogonal to the first reflecting surface, and configured to reflect a reflected light reflected from the first reflecting surface toward the first surface side,
in each reflector row of the plurality of reflector rows, an angle between a first straight line at which the first reflecting surface and the second reflecting surface meet and a plane in which the first direction and a second direction intersect is set to a value greater than 0° and less than 90°,
an angle between the first reflecting surface and the plane is set to a value greater than 45° and less than 90°,
the plurality of reflector rows include a first reflector row in which the angle between the first straight line and the plane is set to a smallest value among those of the plurality of reflector rows,
reflector rows other than the first reflector row are configured such that the angle between the first straight line and the plane is set to values that increase away from the first reflector row in one direction along the second direction.
